(19) United States
(12) Patent Application Publication
(10) Pub. No.: US 2019/0026838 A1
(43) Pub. Date: Jan. 24, 2019

(54) METHOD AND SYSTEM FOR PROCESSING DATA THAT DISAGREES

(71) Applicant: BITTER N TWISTED ENTERPRISES PTY LTD, Ringwood, Victoria (AU)

(72) Inventors: Kenneth TAN, Doncaster East (AU); Robert DREW, Ringwood (AU)

(21) Appl. No.: 16/067,010

(22) PCT Filed: Dec. 23, 2016
(86) PCT No.: PCT/AU2016/051292

§ 371 Date: Jun. 28, 2018

(30) Foreign Application Priority Data
Jan. 6, 2016 (AU) 2016900029

(51) Int. Cl. G06Q 40/00; G06F 11/14; G06Q 50/18

(52) U.S. Cl. CPC G06Q 40/12; G06F 11/1446; G06F 2201/84; G06F 2201/80; G06Q 50/18

(57) ABSTRACT

A system for processing data sets that disagree, comprising: an input for receiving a plurality of data sets of corresponding elements from a respective plurality of corresponding users and to receive amendment input from at least one of the users; a memory for storing the plurality of data sets; a negotiation engine for comparing elements of corresponding elements of the data sets and identifying one or more corresponding elements of the data sets that are not in agreement across all of the data sets; an output for outputting the corresponding elements of the data sets that are not in agreement across all of the data sets to the users; and a prompts and messages engine configured to alert the users to the one or more elements of the respective data set corresponding to the respective user that are not in agreement across all of the data sets. The negotiation engine is further configured to respond to receiving amendment input by amending at least one of the data sets according to the amendment input and checking whether there remain any corresponding elements of the data sets that are not in agreement across all of the data sets.

### TECHNICAL FIELD

The present invention relates to a method and system for processing data that disagrees, and reconciling or resolving disagreement in such data sets.

### BACKGROUND

Computing systems commonly comprise multiple data inputs, including in some cases from different sources and, in some instances, conflicts or inconsistencies can arise between different data streams or data sets. Such inconsistencies are of particular concern when two (or more) data streams or data sets are purportedly indicative of a single physical or other parameter so should agree.

Such disagreement is handled in various ways. In some cases, two data streams or sets may represent a continuously variable natural parameter such that, while in principle the two data streams or sets should agree, a level of disagreement is tolerable. For example, the air temperature indicated by the outputs of two closely situated digital thermometers should be identical, but small differences will commonly be encountered; in such a situation, reconciliation by averaging the two measurements will generally be acceptable.

In other cases, three or more data streams or sets that should agree may be received, but may be found not to agree. This disagreement may be resolved in a number of ways. For example, if one output disagrees with the other outputs, which are themselves in agreement, the divergent output is disregarded. Alternatively, if a first plurality of such outputs is in mutual agreement, and a second plurality of outputs is in mutual agreement and disagree with the first plurality, the second plurality of outputs may be disregarded. These scenarios can arise in, for example, during the automated control of vehicles employing multiple sensor inputs.

Furthermore, data reconciliation may be required following relationship dissolution, such as in the division of property—during which different parties may have arrived at different estimates of respective assets and the like.

However, while some techniques for data reconciliation are known, even when such techniques are employed—and in scenarios where they are not employed—disagreement of data can impede the execution of subsequent processes. These subsequent processes may, for example, employ the data in which the disagreement has been detected, so it may not be possible to proceed until the disagreement has been resolved.

### SUMMARY OF THE INVENTION

According to a first broad aspect of the present invention, there is provided a method for processing data sets that disagree, comprising:
a) receiving a plurality of data sets of corresponding elements from a respective plurality of corresponding users;
b) comparing elements of corresponding elements of the data sets;
c) identifying one or more corresponding elements of the data sets that are not in agreement across all of the data sets;
d) outputting the corresponding elements of the data sets that are not in agreement across all of the data sets to the users (whether in the form of the names of those elements, their contents, or otherwise);
e) alerting the users to the one or more elements of the respective data set corresponding to the respective user that are not in agreement across all of the data sets (and optionally requesting amendment input);
f) receiving amendment input from at least one of the users;
g) amending at least one of the data sets according to the amendment input; and
h) checking whether there remain any corresponding elements of the data sets that are not in agreement across all of the data sets.

In an embodiment, first and second data sets are received from first and second corresponding users. In this embodiment, the method comprises:
a) receiving at least first and second data sets of corresponding elements from respective first and second users;
b) comparing elements of the first data set and corresponding elements of the second data set;
c) identifying elements of the first data set that disagree with corresponding elements of the second data set;
d) outputting the corresponding elements of the first and second data sets that disagree to the users;
e) alerting the first user to the elements of the first data set that disagree with the corresponding elements of the second data set and prompting the second user to amend the elements of the second data set that disagree with the corresponding elements of the first data set;
f) receiving amendment input from at least one of the first and second users;
g) amending at least one of the first and second data sets according to the amendment input; and
h) checking whether there remain any elements of the first data set that disagree with corresponding elements of the second data set.

It will be appreciated that, herein, whilst embodiments and scenarios may be described by reference to only two users/individuals and two corresponding data sets, this represents a minimum number of users and corresponding data sets.

The method may include repeating steps c) to h) one or more times until there remain no corresponding elements of the data sets that are not in agreement across all of the data sets.

In an embodiment, the method includes at least partially further processing the corresponding elements of the data sets that agree across the data sets while continuing to resolve or awaiting resolution of disagreement between the one or more corresponding elements of the data sets that are not in agreement across all of the data sets.

In one embodiment, the method includes splitting each of one or more corresponding elements of the data sets into a plurality of elements.

In one example, at least some of the elements of the data sets correspond to financial values. In one example, at least some of the elements of the data sets correspond to periods of time allocated to a given user.

In an embodiment, the method further comprises flagging the corresponding elements of the data sets that are not in agreement across all of the data sets (e.g. as “undecided” or “value to be agreed”), or storing or flagging the corresponding elements of the data sets that are not in agreement across all of the data sets as undecided.

In another embodiment the method further comprises displaying the elements or data indicative of the elements (e.g. the sum of the values of the elements or a map representation of the elements) to the users.

In an embodiment, at least some of the elements of the data sets correspond to assets, liabilities or financial resources of the users.

In another embodiment, at least some of the elements of the data sets correspond to child or other dependent access (such as child or pet access days).

When at least some of the elements of the data sets correspond to dependent access, the method may comprise presenting to a user a plurality of tools (constituting a data input mechanism) configured to control a child negotiation module that is controllable to negotiate the dependent access. The plurality of tools may comprise one or more of (i) a drop down menu listing common dependent access patterns, (ii) a grid comprising one or more (‘n’) weeks (such as a fortnightly grid and/or as a n×7 day grid), and (iii) a selectively viewable full calendar. These tools may be controllable to create access periods by creating and dragging and dropping blocks of time.

The method may further comprise displaying the elements or data indicative of the elements (e.g. the sum of the values of the elements or a map representation of the elements) to the users grouped or flagged into a plurality of pools of elements. In this embodiment, the elements of the data sets may correspond to assets, liabilities or financial resources of the users and the pools of elements include pools corresponding to the respective assets, liabilities or financial resources of the respective users.

The pools of elements may include at least one pool of corresponding elements of the data sets that are not in agreement across all of the data sets. Furthermore, the method may include providing the users with a mechanism for moving at least some of the elements between pools.

In one embodiment, the method further comprises preparing statistical information from two or more sets of the plurality of said sets of data, and sending respective messages based at least in part on the statistical information to one or more of the users. For example, the respective message may comprise at least one recommendation. The recommendation may recommend an expert (such as a psychologist or a valuer).

In an embodiment, the method further comprises generating either automatically or upon user prompting a data snapshot at a point in time comprising selected elements of the data sets and/or of data derived therefrom, and outputting the data snapshot, saving the data snapshot, or sending the data snapshot to one or more of the users.

In this embodiment, the data snapshot may comprise any one or more of (i) a financial statement, (ii) a financial negotiation outcome, and (iii) a dependent access outcome. The method may include sending the data snapshot to one or more of the users for agreement.

The data snapshot may be loaded as the current state of any stage or stages of the method (such as into modules that implement the method), and may be used to contribute to an overall matter timeline which any of the users can rely on as a timeline for auditing or evidentiary purposes.

The method may also include measuring one or more financial positions at a point in time, such as for one or more commercial arrangements (e.g. family business succession when new partnering arrangements are being established).

The method may include generating events that in aggregate comprise a matter timeline comprising one or more events of the method (whether the events are performed automatically or in response to a user action).

According to a second broad aspect of the present invention, there is provided a system for processing data sets that disagree, comprising:
an input for receiving a plurality of data sets of corresponding elements from a respective plurality of corresponding users and to receive amendment input from at least one of the users;
a memory for storing the plurality of data sets;
a negotiation engine for comparing elements of corresponding elements of the data sets and identifying one or more corresponding elements of the data sets that are not in agreement across all of the data sets;
an output for outputting the corresponding elements of the data sets that are not in agreement across all of the data sets to the users; and
a prompts and messages engine for alerting the users to the one or more elements of the respective data set corresponding to the respective user that are not in agreement across all of the data sets (and optionally requesting amendment input);
wherein the negotiation engine is further configured to respond to receiving amendment input by amending at least one of the data sets according to the amendment input and checking whether there remain any corresponding elements of the data sets that are not in agreement across all of the data sets.

In an embodiment, the method comprises a produce orders manager for producing orders indicative of the data sets amended according to the amendment input.

Thus, the method may include producing orders indicative of the current state of the plurality of datasets (such as contained in the various modules in the system implementing the method), and in response to relevant user input and consequential agreement between the users.

In an embodiment, the system is configured to:
i) identify one or more corresponding elements of the data sets that are not in agreement across all of the data sets;
ii) output the corresponding elements of the data sets that are not in agreement across all of the data sets to the users;
iii) alert the users to the one or more elements of the respective data set corresponding to the respective user that are not in agreement across all of the data sets;
iv) receive amendment input from at least one of the users;
v) amend at least one of the data sets according to the amendment input; and
vi) check whether there remain any corresponding elements of the data sets that are not in agreement across all of the data sets.

The system may be configured to repeat steps i) to vi) one or more times until there remain no corresponding elements of the data sets that are not in agreement across all of the data sets.

The system may be configured to at least partially further process the corresponding elements of the data sets that agree across the data sets before disagreement between the one or more corresponding elements of the data sets is resolved.

In an embodiment, the system is controllable to split each of one or more corresponding elements of the data sets into a plurality of elements.

In an embodiment, at least some of the elements of the data sets correspond to:
i) financial values;
ii) assets, liabilities or financial resources of the users; and/or
iii) dependent access (such as child or pet access days).

When at least some of the elements of the data sets correspond to dependent access, the system may include a child negotiation module controllable to negotiate the dependent access and having a plurality of tools (constituting a data input mechanism) presentable to the user, wherein the tools are configured to control the child negotiation module. It will be appreciated that, though referred to as a child negotiation module, this module may alternatively be referred to as a dependent negotiation module as the functionality for negotiating access to children, pets and other dependents is identical.

The plurality of tools may comprise one or more of (i) a drop down menu listing common dependent access patterns, (ii) a grid comprising one or more (‘n’) weeks (such as a fortnightly grid and/or as a n×7 day grid), and (iii) a selectively viewable full calendar. These tools may be controllable to create access periods by creating and dragging and dropping blocks of time.

In one embodiment, the system is operable to flag the corresponding elements of the data sets that are not in agreement across all of the data sets, or store or flag the corresponding elements of the data sets that are not in agreement across all of the data sets as undecided.

The system may be configured to display the elements or data indicative of the elements to the users.

The system may be configured to display the elements or data indicative of the elements to the users grouped or flagged into a plurality of pools of elements.

The system (for example in a financial statement module) may be configured to display the elements or data indicative of the elements to the users in column format (to cater for a plurality of users, with one column per user).

The system (for example in a financial statement module) may be configured by the user to display the elements or data indicative of the elements to the users as lists where there are two users, with each user being able to select a preferred view separately (column or list). Thus, a list format allows easier rendering on smaller device screens, such as on mobile phones or tablets or laptops with smaller screens or screen capacity.

In an embodiment, the elements of the data sets correspond to assets, liabilities or financial resources of the users and the pools of elements include pools corresponding to the respective assets, liabilities or financial resources of the respective users. In this embodiment, the pools of elements may include at least one pool of corresponding elements of the data sets that are not in agreement across all of the data sets. The system may include a reallocation mechanism operable to move at least some of the elements between pools.

In an embodiment, the system further comprising a monitoring and reporting engine. The monitoring and reporting engine may be configured to prepare statistical information from two or more sets of the plurality of said sets of data, wherein the prompts and messages engine is further configured to send respective messages based at least in part on the statistical information to one or more of the users. For example, the respective message may comprise at least one recommendation. The recommendation may recommend an expert (such as a psychologist or a valuer).

The system or its component modules (e.g. a financial statement, a financial negotiation, a child negotiation or a produce orders module) may be configured to generate either automatically or upon user prompting a data snapshot at a point in time comprising selected elements of the data sets and/or of data derived therefrom, and to output the data snapshot, save the data snapshot, or send the data snapshot to one or more of the users.

The system or one or more of its component modules may be configured to generate events that in aggregate comprise a matter timeline comprising one or more events in the system.

According to a third broad aspect of the present invention, there is provided computer software configured to, when executed by one or more processors of a computing device, control the device to implement the method of the first broad aspect. According to this aspect, there is also provided a computer readable medium comprising such computer software (in one example stored in non-transitory form).

It should be noted that any of the various individual features of each of the above aspects of the invention, and any of the various individual features of the embodiments described herein including in the claims, can be combined as suitable and desired.

### BRIEF DESCRIPTION OF THE DRAWINGS

In order that the invention can be more clearly ascertained, embodiments will now be described, by way of example, with reference to the accompanying drawings, in which:

FIG. 1 is a schematic diagram of a system for performing data reconciliation according to an embodiment of the present invention;

FIG. 2 is a schematic view of the page displayed by the login module of the system of FIG. 1 according to an embodiment of the present invention;

FIG. 3 is a schematic view of the required fields displayed by the login module of FIG. 2 according to an embodiment of the present invention;

FIG. 4 is a schematic view of a profile page generated by the profile module of the system of FIG. 1 according to an embodiment of the present invention;

FIG. 5 is a schematic view of the page displayed by the financial statement module of the system of FIG. 1 according to an embodiment of the present invention;

FIG. 6 is an example of ASSETS or LIABILITIES displayed by the financial statement module of FIG. 5 according to an embodiment of the present invention;

FIG. 7 is a schematic view 140 of the page generated by a financial negotiation module of the system of FIG. 1 according to an embodiment of the present invention;

FIGS. 8A and 8B present a schematic view of the page generated by the child negotiation module of the system of FIG. 1 according to an embodiment of the present invention;

FIG. 8C is a schematic view of the page generated by the child negotiation module of the system of FIG. 1 according to another embodiment of the present invention;

FIG. 9 is a schematic view of the page generated by produce orders manager of the system of FIG. 1 according to an embodiment of the present invention;

FIGS. 10A and 10B present a flow chart of the process implemented by the financial statement module of the system of FIG. 1 according to an embodiment of the present invention;

FIGS. 11A and 11B present a flow chart of the process implemented by the financial negotiation module of the system of FIG. 1 according to an embodiment of the present invention; and

FIGS. 12A and 12B present a flow chart of the process implemented by the child negotiation module of the system of FIG. 1 according to an embodiment of the present invention.

### DETAILED DESCRIPTION

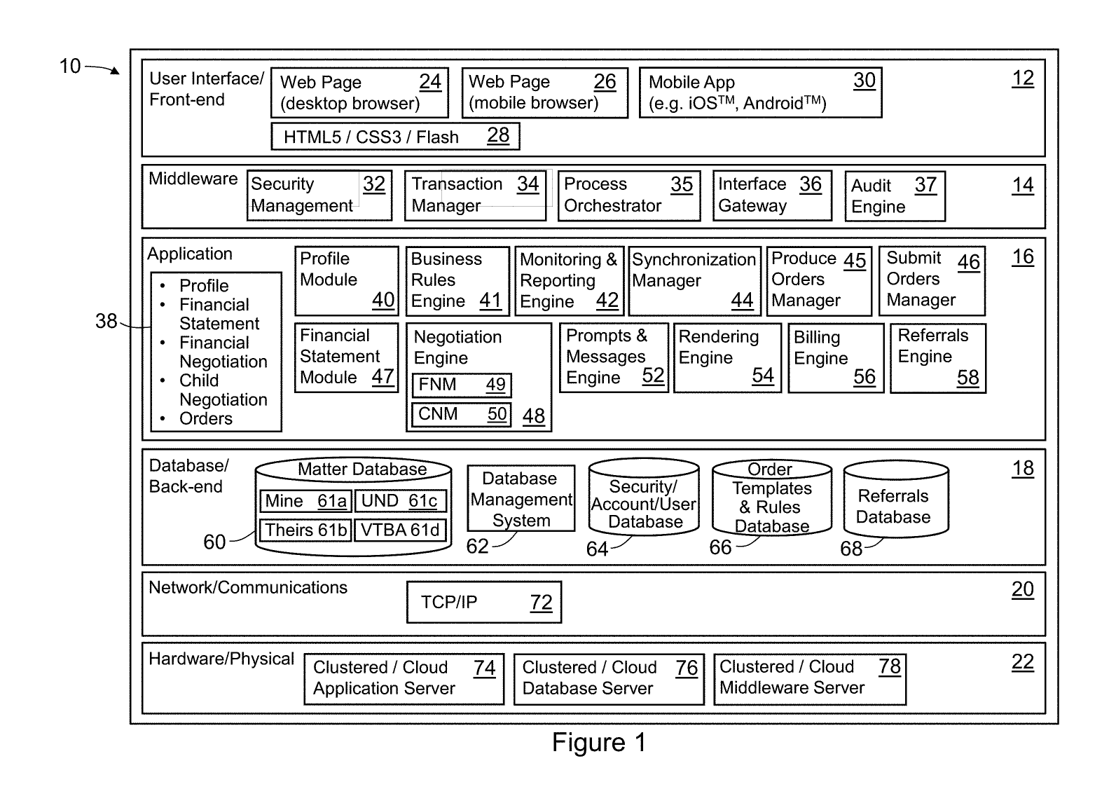

According to an embodiment of the present invention, there is provided a system 30, as shown in high-level architectural form in FIG. 1, for performing data reconciliation according to an embodiment of the present invention. System 10 facilitates the reconciliation of plural parallel data streams or data sets that contain data disagreements. In broad terms, system 10 is adapted to receive these data streams or sets from a plurality of users. In the example presented below, the data concerns personal, relationship, child-related and financial details for use during mediation, negotiation and settlement. This allows the users to employ system 10 to negotiate financial and child- or pet-related outcomes from, for example, home. System 10 includes consent order templates, and is configured to generate consent orders based on the data streams or sets once reconciled and agreed by the users, for endorsement—for example—by a Court or other appropriate authority, such as by interfacing with the Court's case management system.

System 10 is also adapted to provide referrals to experts (e.g. asset valuers, child psychologists) as desired, and is configured to protect private information and is operable to purge selected (e.g. financial) information relating to a specific matter once the relevant phase has been completed. System 10 allows parties related to the users (e.g. family members) to participate in the settlement process, and for associated parties (such as legal representatives) to observe the process without participating directly in the negotiation.

For convenience, the service implemented by system 10 is referred to herein as ‘My Separation’ or ‘SimplySeparate.com’.

System 10, by facilitating the division of financial resources and the resolution of child and/or pet access, may reduce demand for Court time (judges, associates, and facilities) and expense, as well as personal time, expense and acrimony. System 10 can be used in the separation of assets and the agreement on child access at any point in a relationship but will typically be employed during the break-down of the relationship. System 10 can also be used to capture relationship and financial information at the commencement of co-habitation, support relevant mediation during a relationship, and support on-going negotiation, such as of child access, after final settlement and orders are obtained from the Court. For example, the tool to support agreement of child and/or pet access can be used each school term or each year to agree on child or pet access for the following period, allowing adjustments to be made as children or pets grow up. The same tools can also be used to measure one or more financial positions at a point in time for a range of commercial arrangements including family business succession when new partnering arrangements are being established.

The key functions of system 10 include:
1. Capturing information about the individuals that is required to agree on an outcome (including reconciling differences in inputted data) and to document that outcome (pertaining to, for example, financial matters and children);
2. Documenting the financial position (including agreeing on values of assets, liabilities and financial resources);
3. Negotiating a financial split which can be done in the couples own time, and from the comfort of their own homes (compared to today where lawyers and a mediation facility are needed, and the solicitors and barristers charge for the time that the couple are actually considering their outcomes);
4. Negotiating child and/or pet access to clarify for all interested parties and minimise detriment to the children;
5. Producing a set of Consent Orders for review and finalisation by lawyers and/or a Court.

System 10 includes workflows that encourage consensus and prompt progress, to ameliorate the emotional stress associated with relationship dissolution. System 10 is adapted to accommodate a range of relationship types, financial portfolio complexity, and child parenting or pet care arrangements, and will support multiple jurisdictions.

System 10 comprises several layers: a user interface/front end 12, a middleware layer 14, an application layer 16, a database/back-end 18, a network/communications layer 20, and a hardware/physical layer 22.

User interface/front end 12 includes a desktop browser web page 24 and a mobile browser web page 26, built using known web technology, such as HTML5, CSS3 and/or Flash 28; the primary mechanism to access system 10 is thus via a web browser. User interface/front end 12 also includes a mobile application 28: a subset of features may be provided to native applications built for mobile devices using the iOS and Android ecosystems.

### Security Management

System 10 may be hosted with an external provider with an Application Service Architecture (ASA) approach providing infrastructure as a service. The service provider may have a database-generated encryption key for communications to and from the web server, and optionally a Hardware Security Module (HSM). The database server using the hardware device automatically and transparently encrypts stored data. The Application layer will also be responsible for encrypting selected data as part of the defined business logic. The user will have minimal or no responsibility for encryption, and the majority of the encryption will occur under the control of the Synchronisation Manager (described below) of application 16.

System 10 implements role-based access to application functionality and record-level access to the underlying database, comprising at least four roles with the following access matrix:

| | | Financial | Financial | Child | Produce | | |
|---|---|---|---|---|---|---|---|
| Role | Profile | Statement | Negotiation | Negotiation | Orders | Application | Database |
| User | RWX | RWX | RWX | RWX | RWX | | |
| | | | (if paid) | (if paid) | (if paid) | | |
| Trusted | R | R | R | R | R | | |
| Party/Guest | | | | | | | |
| Administrator | | | | | | Configure | Monitor |
| | | | | | | Manage | health |
| | | | | | | application | |
| | | | | | | Manage | |
| | | | | | | accounts | |
| Database | | | | | | | Maintain |
| Administrator | | | | | | | |

Middleware layer 14 of system 10 includes a security management tool 32 including associated processes to add, delete or modify the access rights and permissions for roles and individual users. This may be provided by the hosting and application service provider, but can be—as described above—an in-house function.

Security management tool 32 may make use of a database to user, account and role based access permission data. Middleware 14 also includes a transaction manager 34, a process orchestrator 35, an interface gateway 36 and an audit engine 37. Transaction manager 34 is a Transaction Management Layer, provided to support session-based access to system components and services provided by application 16 and back-end 18. Process orchestrator 35 may be implemented, to provide process orchestration, either within transaction manager 34 or—as illustrated—as a separate component within middleware layer 14.

Application 16 has core components 38 for managing profiles, financial statements, financial negotiation, child negotiation and orders (described below). Application 16 includes a profile module 40, a business rules engine 41, a monitoring and reporting engine 42, a synchronization manager 44, a produce orders manager 45, a submit orders manager 46, a financial statement module 47, a negotiation engine 48 (which includes a financial negotiation module 49 and a child negotiation module 50), a prompts and messages engine 52, a rendering engine 54, a billing engine 56, and a referrals engine 58. Core components 38—although depicted as a discrete set of elements in FIG. 1—are implemented by—inter alia—profile module 40, business rules engine 41, monitoring and reporting engine 42, synchronization manager 44, produce orders manager 45, submit orders manager 46, financial statement module 47, negotiation engine 48, prompts and messages engine 52, rendering engine 54, billing engine 56, and referrals engine 58. It should be noted that, though referred to as a ‘child negotiation module’, child negotiation module 50 can be used to negotiate access, etc, in respect of other dependents, such as pets.

Database/back-end 18 includes a matter database 60, a database management system 62, a security/account/user database 64, an order templates and rules database 66 and a referrals database 68.

Network/communications layer 20 implements TCP/IP 72. Hardware/physical layer 22 includes a clustered/cloud application server 74, a clustered/cloud database server 76 and a clustered/cloud middleware server 78.

Security management tool 32 manages encryption of relevant user-related data, and may interact with business rules engine 41 of application 16, database management system 62 of database/back-end 18, transaction manager 34 and process orchestrator 35 of middleware layer 14, and the various components of application 16 so that personal and private data are handled securely and appropriately in an integrated fashion.

### Transaction Management, Process Orchestration and Component Integration

System 10—via middleware layer 14 and/or application 16—provides web services (e.g. REST or SOAP) based APIs invoked by user interface/front-end 12. The actual approach may be constrained by what is available via the application service provider.

### Core Application Components

As described above, the core functionality 38 of application 16 comprises a number of modules, one for each user-facing component, including:
1. Login/Account Setup
2. Profile
3. Financial Statement
4. Financial Negotiation
5. Child Negotiation
6. Orders

### Negotiation Engine

Negotiation engine 48 facilitates reconciliation of a plurality of distinct data streams or sets, such as data submitted by two or more parties or individuals using system 10. This allows a plurality of parties or individuals to reconcile such data by, in effect, negotiation. For example, this mechanism can be used to negotiate financial and child access outcomes. In the example of a relationship break-down, there are typically two primary individuals involved, but in other examples there may be more than two individuals engaging in such a negotiation.

Negotiation engine 48 supports the participation of at least two individuals during the negotiation process, so negotiation engine 48 can be used more broadly than simply to negotiate financial matters and child access. It may also be used to facilitate estate division (viz. will-related negotiations) and in business matters such as succession planning.

The logic in the core application components 38, the current state of the negotiation (as stored in matter database 60 and other system databases), input from the users (via a user input/output, not shown), input from business rules engine 41, input from synchronisation manager 44 and input from other system components (such as transaction manager 34 and process orchestrator 35) are used by application 16 to update the current state of the negotiation.

Negotiation engine 48 supports both turn-based, and parallel negotiation approaches, reverse auction, and conventional bidding approaches.

### Business Rules Engine

Business rules engine 41 encodes business rules relevant to particular modules or components. For example, a business rule may state that: IF a user wants to make use of the Child Negotiation functionality, then the Child Names, Ages and Birthdays need to be populated in the Profile Page.

### Prompts and Messages Engine

Application 16 is configured to encourage consensus and to accelerate resolution. To that end, application 16 displays on-screen messages or sends reminders (e.g. time based) to the users as they progress through a negotiation. (A display is not depicted in FIG. 1, but it will be appreciated by those skilled in the art that such displaying—here and as discussed elsewhere herein—will typically be done to the display of the respective users' personal computing device (whether desktop computer, mobile device or otherwise). These messages are rules based. Prompts and messages engine 52 may be a separate back-end component of application 16 (as illustrated) or be implemented as part of business rules engine 41.

Examples of rule-based messages that may be displayed on certain pages of the website include:
1) RULE: When the % (by value) of assets agreed between the negotiating parties exceeds 80%, display a message “You're almost there, only $x (y items) to agree and you're done. Keep going!”
2) If negotiation has been underway (from the time of the first sync) for more than two months and the users have not logged in, email individuals a message: “We haven't seen you for a while. Congratulations if you have managed to reach agreement. If not, we are here to help you. Just click here: [insert link to website]” (final messages and rules to be confirmed)

Prompts and messages engine 52 inserts messages, once displayed, into a back-end message log (not shown) to facilitate the optimization of the frequency and repetitiveness of messages. For example, prompts and messages engine 52 will refrain from annoying a user by sending the same “you have achieved 80% agreement” multiple times in a short period of time.

### Monitoring and Reporting Engine

Monitoring and reporting engine 42 summarises statistics (though no data about individual matters or individuals is accessible) concerning numbers of matters, matter duration, demographics of the users, average financial portfolio value. Monitoring and reporting engine 42 can be controlled to present these statistics graphically and allow filtering by any of the dimensions in the underlying database, such as time period, postcode and other demographics, portfolio value and so forth.

The reporting and monitoring analytics generated by monitoring and reporting engine 42 may be provided to prompts and messages engine 52 as input into messages to be presented to users. For example, a message may be presented indicating that the financial or child time split is within x % of the mean of the pasty settlements facilitated by application 16.

### Synchronisation Manager

Synchronisation manager 44 manages synchronisation of sessions between users. Synchronisation manager 44 makes use of other system components (such as business rules engine 41) or may contain the synchronisation protocols (including encryption).

### Rendering Engine

Rendering Engine 54 takes raw information that is stored in the various databases 60, 64, 66, 68 of system 10 (e.g. the current state of negotiation from each individual's perspective), and renders the data in manner subject to presentation templates of system 10 (not shown) that define the ‘look and feel’ of each system component. Rendering engine 54 takes input (the current state) from negotiation engine 48 and manages the rendering of the resultant screens in the user interface/front-end 12. Rendering engine 54 also contains rendering rules that take into consideration the nature of the user device (e.g. PC, mobile phone, table or watch) and adjusts the rendering to match the display capabilities of the target user device.

### Produce Orders Manager

Produce orders manager 45 manages the production of draft orders. Produce orders manager 45 may draw input from the components of application 16, may employ their associated data, and may receive input from business rules engine 41 or other system engines, as well as interact with transaction manager 34 and process orchestrator 35. Orders need to be compliant with the relevant jurisdiction where they are to be submitted (for endorsement by the relevant Court or authority), so order templates and rules database 66 includes geographically- or jurisdictionally-localised orders templates and order production rules.

### Submit Orders Manager

Submit orders manager 46 interfaces with the relevant Family Court registry systems. The registry systems will be specific to the relevant Court and jurisdiction, so submit orders manager 46 is configured to interface with a range of such external systems via interface gateway 36 of middleware 14, which provides web services to push data to target external systems, and or use pull web services from the external registry systems to carry out the submissions. Submit orders manager 46 may make use of business rules engine 41, transaction manager 34, process orchestrator 35 and synchronisation manager 44, and other system engines or components.

### Interface Gateway

Interface gateway 36 facilitates all in-bound and out-bound data transfers to and from system 10. Interface gateway 36 is used by submit orders manager 46 to interface with Court registry systems, but may also be used to interface to other types of third-party systems such as database and booking systems for financial and psychiatric or psychological experts. There are a number of components of system 10 that can trigger referrals to such experts for specialist advice such as asset valuations and family reports, and such requests or bookings or referrals can be facilitated by interface gateway 36.

### Audit Engine

Audit engine 37 monitors progress, and logs and time-stamps each interaction all individuals have with application 16. These interactions include but are not limited to: the date and time that each individual first registered with the website, when they purchased each paid module (if they did), the date and time the individuals commenced negotiating their financial and/or child access settlement, the date the individuals reached agreement on their financial and/or child access settlement, the date and time of the current set of consent orders and so forth. Audit engine 37 manages an audit log or table (not shown), stored in matter database 60, which allows monitoring and reporting engine 42 also to track average time to reach agreement across the various matters facilitated by system 10.

For each message communicated to a user, an entry is made in the audit table/matter feed with a date (dd:mm:yyyy) and timestamp (hh:mm:ss). For each item added to the Audit Table/Matter Feed, the relevant Matter ID and Participant ID for the initiator is added to the audit table. Items in square brackets in the following table of Business Requirements of Audit Entries (stored in and managed by business rules engine 41) are field names to be populated.

| Source | | |
|---|---|---|
| Module | Trigger | Message |
| Login | A user signs up | New User joined—new |
| | | Participant ID ([Participant ID |
| | | created]) created |
| | A new Matter created | New Matter Commenced—new |
| | | Matter ID ([Matter ID]) created |
| | A Participant invites | Participant [Participant ID] |
| | another Participant | invited [Invitee Name] |
| | A Participant joins a Matter | Participant [Participant ID— |
| | by accepting an invitation | Invitee] joined Matter [Matter |
| | from another Participant | ID] by accepting an invite |
| | | from Participant [Participant |
| | | ID—Inviter] |
| | A Participant joins a Matter | Participant [Participant ID— |
| | by entering a Matter ID | Invitee] joined Matter [Matter |
| | | ID] entering a Matter ID |
| | A participant invites | Participant [Participant ID] |
| | another user to be a “view | invited VIEW ONLY user |
| | only” user | [Invitee Name] |
| | A Participant joins a Matter | Participant [Participant ID— |
| | as a “view only” user by | Invitee] joined Matter [Matter |
| | accepting an invitation | ID] as a “view only” user by |
| | from another Participant | accepting an invite from |
| | | Participant [Participant ID— |
| | | Inviter] |
| Profile | Profile saved | Participant [Participant ID] |
| | | saved their profile |
| | Profile complete | Participant [Participant ID] |
| | | completed their profile |
| Financial | First use of (click on) the | Participant [Participant ID] |
| Statement | Financial Statement | accessed the Financial |
| | Module | Statement for the first time |
| | When a Participant initiates | Participant [Participant ID] |
| | a sync of their Financial | synced their Financial |
| | Statement | Statement |
| | An ASSET value is | Asset [Asset ID] is disputed |
| | disputed | |
| | A LIABILITY value is | Liability [Liability ID] is |
| | disputed | disputed |
| | A FINANCIAL | Financial Resource [Resource |
| | RESOURCE value is | ID] is disputed |
| | disputed | |
| | An ASSET value is agreed | Asset [Asset ID] is agreed |
| | A LIABILITY value is | Liability [Liability ID] is |
| | agreed | agreed |
| | A FINANCIAL | Financial Resource [Resource |
| | RESOURCE value is | ID] is agreed |
| | agreed | |
| | New ASSET added | New ASSET added by |
| | | Participant [Participant ID]— |
| | | new Asset ID ([Asset ID]) |
| | | created |
| | New LIABILITY added | New LIABILITY added by |
| | | Participant [Participant ID]— |
| | | new Liability ID ([Liability |
| | | ID]) created |
| | New FINANCIAL | Financial Resource [Resource |
| | RESOURCE added | ID] is added |
| | An ASSET is deleted | Asset [Asset ID] deleted by |
| | | Participant [Participant ID] |
| | A LIABILITY is deleted | Liability [Liability ID] deleted |
| | | by Participant [Participant ID] |
| | A FINANCIAL | Financial Resource [Resource |
| | RESOURCE | ID] is deleted |
| | is deleted | |
| Financial | First use of (click on) the | Participant [Participant ID] |
| Negotiation | Financial Negotiation | accessed the Financial |
| | Module | Negotiation Module for the |
| | | first time |
| | When there are ≥ 2 users | Financial Negotiation |
| | with access to the Financial | commenced on Matter [Matter |
| | Negotiation Module, and | ID] |
| | one of them drags an item | |
| | from the undecided list for | |
| | the first time (i.e. the time | |
| | the negotiation started) | |
| | A Participant clicks on an | Participant [Participant ID] |
| | offer for a 3rd-party | clicked on Link {Referral Link |
| | recommendation | ID] |
| | A Participant sends an offer | Participant [Participant ID— |
| | to another Participant | offerer] sent an offer to |
| | | Participant [Participant ID— |
| | | offeree] |
| | A Participant accepts an | Participant [Participant ID— |
| | offer to another Participant | offeree accepted an offer from |
| | | Participant [Participant ID— |
| | | offerer] |
| | When a Participant initiates | Participant [Participant ID] |
| | a sync of the Financial | synced their Financial |
| | Negotiation Module | Negotiation Module |
| | ≥50% of the Net Assets | ≥50% of the Net Assets agreed |
| | agreed | |
| | ≥80% of the Net Assets | ≥80% of the Net Assets agreed |
| | agreed | |
| | 100% or more of the Net | 100% or more of the Net |
| | Assets agreed | Assets agreed |
| | An ASSET has been split | Asset [Asset ID] has been split |
| | between two or more | between Participants [List of |
| | Participants | Participant IDs] |
| | A LIABILITY has been | Liability [Liability ID] has |
| | split between two or more | been split between Participants |
| | Participants | [List of Participant IDs] |
| | A FINANCIAL | Resource [Resource ID] has |
| | RESOURCE has been split | been split between Participants |
| | between two or more | [List of Participant IDs] |
| | Participants | |
| Child | First use of (click on) the | Participant [Participant ID] |
| Negotiation | Child Negotiation Module | accessed the Child Negotiation |
| | | Module for the first time |
| | When there are ≥ 2 users | Child Negotiation commenced |
| | with access to the Child | on Matter [Matter ID] |
| | Negotiation Module, and | |
| | one of them picks one or | |
| | more days on the calendar | |
| | for the first time or uses | |
| | one of the drop down | |
| | patterns (i.e. the time the | |
| | negotiation started) | |
| | A Participant clicks on an | Participant [Participant ID] |
| | offer for a 3rd-party | clicked on Link {Referral Link |
| | recommendation | ID] |
| | A Participant sends an offer | Participant [Participant ID— |
| | to another Participant | offerer] sent an offer to |
| | | Participant [Participant ID— |
| | | offeree] |
| | A Participant accepts an | Participant [Participant ID— |
| | offer to another Participant | offeree accepted an offer from |
| | | Participant [Participant ID— |
| | | offerer] |
| | When a Participant initiates | Participant [Participant ID] |
| | a sync of the Financial | synced their Child Negotiation |
| | Negotiation Module | Module |
| | ≥50% of time has been | ≥50% of time for Child [Child |
| | agreed for a Child | ID] agreed |
| | ≥80% of time has been | ≥80% of time for Child [Child |
| | agreed for a Child | ID] agreed |
| | 100% or more of time has | 100% or more of time for |
| | been agreed for a Child | Child [Child ID] agreed |
| Orders | When a user clicks on the | Participant [Participant ID] |
| | Orders Module (prior to | viewed the Orders Module |
| | purchase) | |
| | The first time any of the | Participant [Participant ID] |
| | users starts using the | used the Orders Module for |
| | Orders Module (e.g. filling | the first time |
| | in questions) | |
| | The first time all the | Ready to produce orders for |
| | relevant information to | the first time |
| | produce a set of complete | |
| | orders is captured in the | |
| | system | |
| | Each time a user with | Participant [Participant ID] |
| | access to the Orders | initiated order production |
| | Module presses the Orders | |
| | button to generate draft | |
| | orders | |
| | A draft set of child interim | Draft set of child interim |
| | orders has been generated | orders has been generated |
| | A draft set of financial | Draft set of financial interim |
| | interim orders has been | orders has been generated |
| | generated | |
| | A draft set of child final | Draft set of child final orders |
| | orders has been generated | has been generated |
| | A draft set of financial final | Draft set of financial final |
| | orders has been generated | orders has been generated |
| Billing | When a user purchases the | Participant [Participant ID] |
| | Financial Negotiation | purchased the Financial |
| | Module | Negotiation Module |
| | When a user purchases the | Participant [Participant ID] |
| | Child Negotiation Module | purchased the Child |
| | | Negotiation Module |
| | When a user purchases the | Participant [Participant ID] |
| | Orders Module | purchased the Orders Module |
| | When a user subscribes | Participant [Participant ID] |
| | monthly | commenced monthly |
| | | subscription |
| | When a user suspends their | Participant [Participant ID] |
| | monthly subscription | suspended their monthly |
| | | subscription |
| | When a user re-instates | Participant [Participant ID] re- |
| | their monthly subscription | instated their monthly |
| | | subscription |
| Expert | A new expert signs up | New Expert joined—new |
| Directory | | Expert ID Expert ID created]) |
| | | created |
| | Expert completes Profile | Expert [Expert ID] completed |
| | | their profile |
| | Expert selected by | Expert [Expert ID] profile |
| | Participant | selected by Participant |
| | | [Participant ID] |

### Billing Engine

Billing engine 56 manages billing and payment for activation of the paid modules or components of the system, such as financial negotiation and child negotiation modules 49, 50 of negotiation engine 48 and produce orders manager 45.

Billing engine 56 may also use interface gateway 36 to coordinate payments with third-parties such as financial services organisations, credit card providers and other financial clearing houses.

### Referrals Engine

There are various stages in the financial and child negotiations where experts are needed to provide input or to break a deadlock. Referrals engine 58 manages the storage of information regarding experts (e.g. child psychologists, property valuers or others). The information stored regarding each expert includes an expert profile, submitted by the respective expert (using an expert profile module (not shown), which requests more information than is requested by profile module 40) upon that expert registering with and signing into system 30. Financial negotiation and child negotiation modules 49, 50 of negotiation engine 48 may display links to the relevant lists of experts, which are drawn from referrals database 68 and facilitated by referrals engine 58.

Optionally, referrals engine 58 may also draw information from other system databases, such as the status of a given financial or dependent (child, pet, etc) negotiation from matter database 60, to determine the context and the appropriate referrals to offer a user.

System 10 also allows experts to be registered (by themselves and/or by the site operators) and allows records about a given expert to be edited, archived, hidden, copied and deleted.

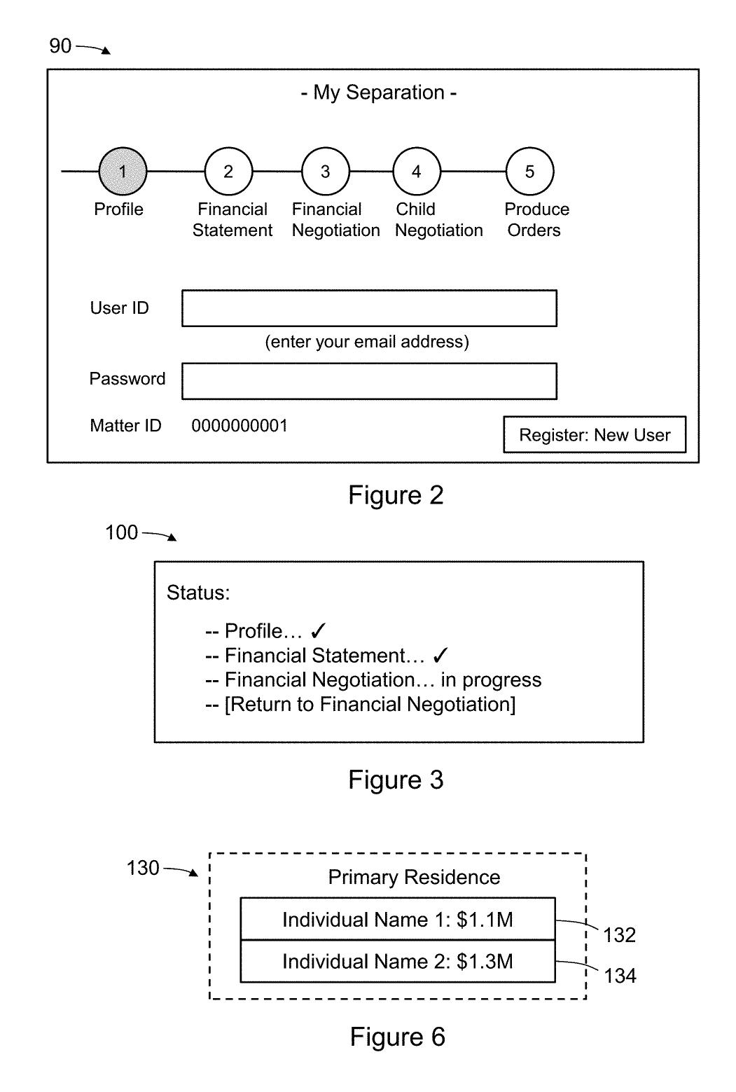

FIG. 2 is a schematic view 90 of the page displayed by the login module of application 16. The login module allows users to sign-up to use the functionality of the site provided by web pages 24, 26, as well as log-in to the secure parts of the site if previously registered. Use of this module is free.

FIG. 3 is a schematic view of a pop-up screen 100 with the required fields, as displayed by the login module in a table, grouped as follows:
User ID (enter email address)
Password (enter password)
Register button for new users

The business rules implemented by the login module, and associated with the unique matter identifier (Matter ID) are as follows:
Matter ID (greyed out, a 10 digit incrementing number e.g. 0000000001
IF Individual 2 is invited to participate or a third-party is invited to SHARE (refer Profile page), THEN the Matter ID is embedded in that link and is automatically assigned]
IF a Matter ID exists, during the new sign-up process (i.e. the other individual has already signed-up and a Matter ID created), THEN there is a field to enter the Matter ID which links the second individual to the matter
IF the sign-up is a result of an invitation from the other individual, THEN the Matter ID will already be populated and greyed out
There is a way to add a Matter ID even after the account has been created in case it has not yet been provided at the time of creation of the second individual's account

If login is unsuccessful, then a retry is afforded with a maximum of 3 attempts and, if still unsuccessful, an email is sent to the user regarding the 3 failed attempts. If successful, system 10 presents pop-up screen 100 (see FIG. 3) and the option to select return to <last screen> or first screen based on the progress of the last session.

If the use of the modules ‘Financial Negotiation’ OR ‘Child Negotiation’ OR ‘Produce Orders’ (implemented by negotiation engine 48 and produce orders manager 45) is not purchased, then pop-up screen 100 does not include the relevant Page names, and the relevant labels indicating those modules are greyed out and cannot be clicked on in the session.

A set of breadcrumbs is displayed on the top of each module/page. Initially, the breadcrumb labels are:
1. Profile
2. Financial Statement
3. Financial Negotiation
4. Child Negotiation
5. Produce Orders

Initially, the Financial Negotiation, Child Negotiation and Produce Orders breadcrumbs are visible but greyed out. IF the user clicks on a greyed-out breadcrumb, they MUST be taken to the relevant page which is displayed greyed out. The user is prompted to purchase the module to make use of it. Billing engine 56 facilitates the process of users purchasing the paid modules in the website.

### Profile

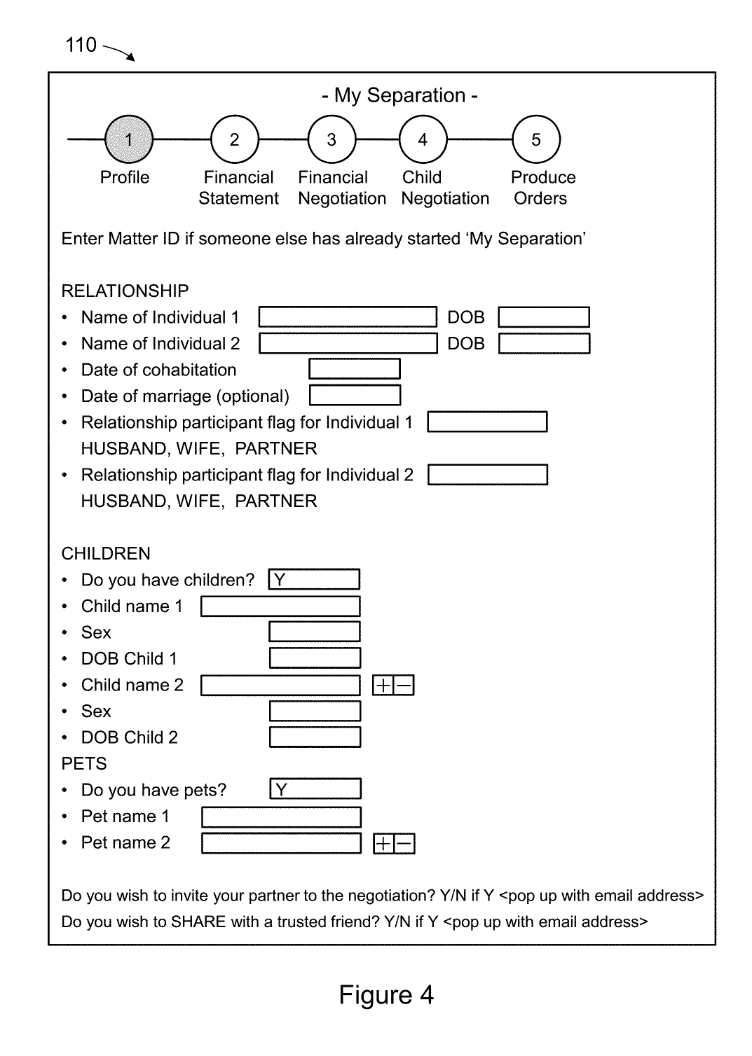

FIG. 4 is a schematic view of a profile page 110 generated by profile module 40 of application 16. Profile module 40 allows a user to capture personal information about themselves and their relationship partner, information about the relationship, and also information about any children and/or pets. This information is used by system 10 to allow the use of other optional features of the site such as the child negotiation functionality, as well as to populate the relevant parts of the draft consent orders if the individual chooses to use that functionality. However, profile module 40 is not controllable to edit personal information (e.g. name) about any other participant in a given matter. Use of this module is free.

### Business Requirements/Rules

The profile page 110 is common to both users so either individual can use this module to edit information in this page. This page includes the following fields, displayed in a table, grouped as follows:

If the other Individual has commenced use of ‘My Separation’, then profile module 40 uses the same Matter ID.
Relationship
   Name of Individual 1 (mandatory)
   DOB of Individual 1 (optional—used for Child Negotiation and Produce Orders) Name of Individual 2 (mandatory)
   DOB of Individual 2 (optional—used for Child Negotiation and Produce Orders)
   Date of cohabitation (mandatory)
   Date of marriage (optional)
   Relationship participant flag for Individual 1—HUSBAND, WIFE, PARTNER (mandatory)
   Relationship participant flag for Individual 2—HUSBAND, WIFE, PARTNER (mandatory)
   Relationship type to dependent 1 for Individual 1—FATHER, MOTHER, AUNT, GRANDPARENT etc
   Relationship type to dependent 2 for Individual 1—FATHER, MOTHER, AUNT, GRANDPARENT etc
   Relationship type to dependent 1 for Individual 2—FATHER, MOTHER, AUNT, GRANDPARENT etc
   Relationship type to dependent 2 for Individual 2—FATHER, MOTHER, AUNT, GRANDPARENT etc
Children
   Do you have children? Y/N If Y, then:
   Child name 1 (optional)
   Gender (optional but mandatory if name populated)
   DOB Child 1 (optional but mandatory if name populated)
   Child name 2 (optional)
   Gender (optional but mandatory if name populated)
   DOB Child 2 (optional but mandatory if name populated)

There is a + and − button positioned against “Child name n” (where n is the last child in the list, in this example 2) to add more children (which will add their name, gender and DOB). There are fields for two children when profile page 110 is initially displayed. If a child is to be deleted, then a confirmation pop-up “Confirm you want to delete Y/N” is displayed.
Pets
   Do you have pets? Y/N if Y, then:
   Pet name 1 (optional)
   Pet name 2 (optional)

A + and − button is positioned against “Pet name n” to add more pets (where n is the last child in the list). There are fields for two pets when the screen is initially displayed. If a pet is to be deleted, then a confirmation pop-up “Confirm you want to delete Y/N” is displayed.

Where Individual 1 wants to invite Individual 2 to the negotiation, a pop-up screen is displayed to Individual 1, which allows input of an email address to send an invitation to Individual 2. The Matter ID is embedded into the invitation and automatically populated for the invited party.

Where one individual wants to share with a trusted friend, a pop-up screen is displayed that allows input of an email address to send an invitation to a third-party. The third-party needs to register with the website and is prompted to do so once they click on the link from the email that they receive. There is no login screen for a trusted friend and the read only session is current for only a point in time for when the link is clicked on (not updated dynamically).

### Financial Statement

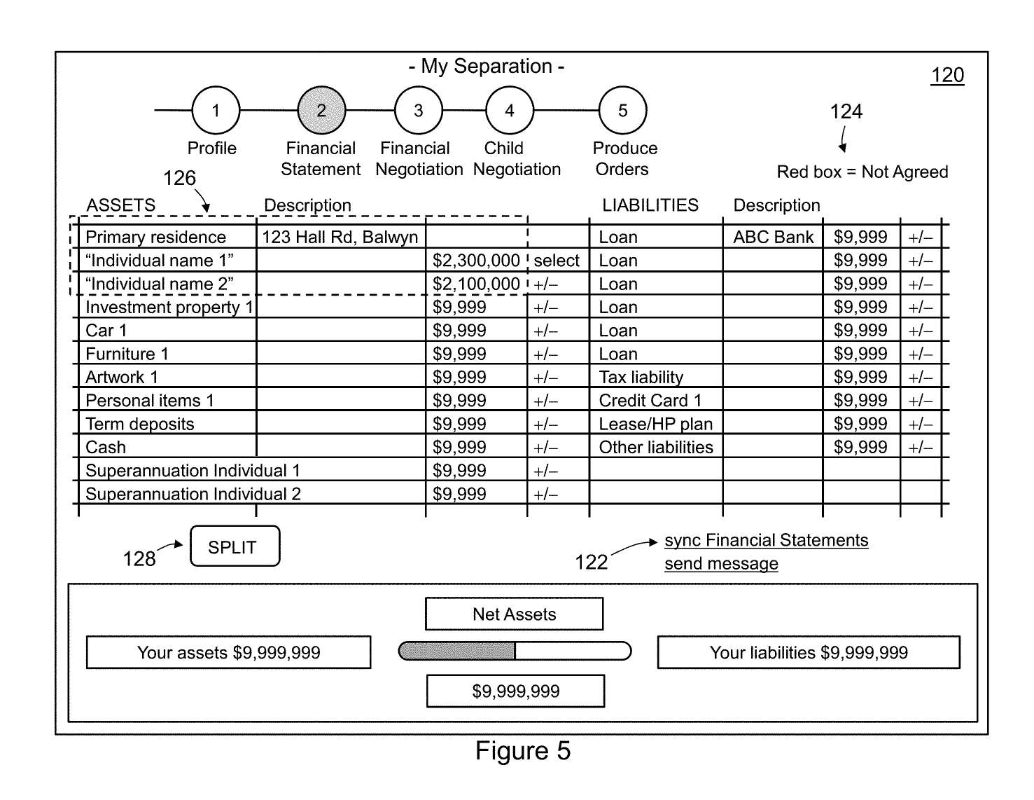

FIG. 5 is a schematic view of a financial statement page 120 displayed by financial statement module 47 of application 16. Financial statement module 47 allows an individual of the plurality of users to input their portfolio of assets, liabilities and financial resources, which is a key input into any subsequent financial negotiation, and into the draft consent orders if the user chooses to use this functionality. In the case of two individuals using this functionality to capture their joint financial position, the site will flag where individuals do and do not agree on the value of a given asset, liability or financial resource. Use of this functionality is free.

### Business Requirements/Rules

The most common ASSETS and LIABILITIES are displayed in a table with an input for the corresponding value (dollar amount) and any associated liability (dollar amount) The grid includes a comment field to allow entry of text notes to uniquely identify the financial statement item (e.g. the street address of a property).

The most common Asset classes include:
Primary Residence
Investment property 1
Car 1
Furniture 1
Art work 1
Superannuation Individual 1
Superannuation Individual 2
Personal items 1
Etc.

The most common LIABILITY classes include:
Mortgage
Personal Loan
Overdraft
Credit Card
Car Loan/HP/Lease

There is a + and − button to add and delete additional ASSETS, LIABILITIES or FINANCIAL RESOURCES; selecting these buttons respectively adds rows to and deletes rows from the table. Any ASSET, LIABILITY or FINANCIAL RESOURCE whose value is not agreed at the commencement or during financial negotiation is listed in a “VALUE TO BE AGREED” pool in the financial negotiation page 120. If the ASSET, LIABILITY or FINANCIAL RESOURCE value is not agreed on, the values that each individual has entered are displayed against the relevant ASSET, LIABILITY or FINANCIAL RESOURCE on the financial negotiation page. Referring to FIG. 6, for example, the label against the relevant ASSET, LIABILITY or FINANCIAL RESOURCE is “Individual 1 Name: $value” in a first box 132, and “Individual 2 Name: $value” in a second box 134 below the first box 132, with a red line (shown as dashed line 136) surrounding both boxes 132, 134.

If the ASSET, LIABILITY or FINANCIAL RESOURCE value is not agreed on, then the values that each individual has entered are displayed against the relevant ASSET, LIABILITY or FINANCIAL RESOURCE in the “VALUE TO BE AGREED” pool on the financial negotiation page. Again, the label against the relevant ASSET, LIABILITY or FINANCIAL RESOURCE will be “Individual 1 Name: $value” in a first box, and “Individual 2 Name: $value” in a second box below the first box, with a red line surrounding both boxes.

An individual can agree to the other user's valuation by selecting the value box provided by the other individual and dragging it onto their corresponding value box in financial statement page 120 or by messaging a revised estimate to the other Individual for agreement. Alternatively, the individuals can click on their value box (local for their session) for the given ASSET, LIABILITY or FINANCIAL RESOURCE, and enter the same value into their respective Financial Statements for the given ASSET, LIABILITY or FINANCIAL RESOURCE. Once the value is agreed on by the parties, the two value boxes will collapse into a single box, the red line surrounding the boxes is removed, and the two values for the relevant ASSET, LIABILITY or FINANCIAL RESOURCE are combined into a single value in the Financial Statement page on the individual's local session and synced with the other individuals valuations once the “sync Financial Statements” link or button (at 122 of FIG. 5) is selected. It should be noted that, for a given individual, the test of whether a value is ‘agreed’ is whether it agrees with the corresponding value provided by the other individual—or individuals—as at the last time the financial statements were synced. If, however, the other (or another) individual has changed the value of the ASSET, LIABILITY or FINANCIAL RESOURCE since the last sync, it may arise that one individual may think he or she is agreeing to the other (or another) individual's value only to have it remain not agreed once the financials are synced again.

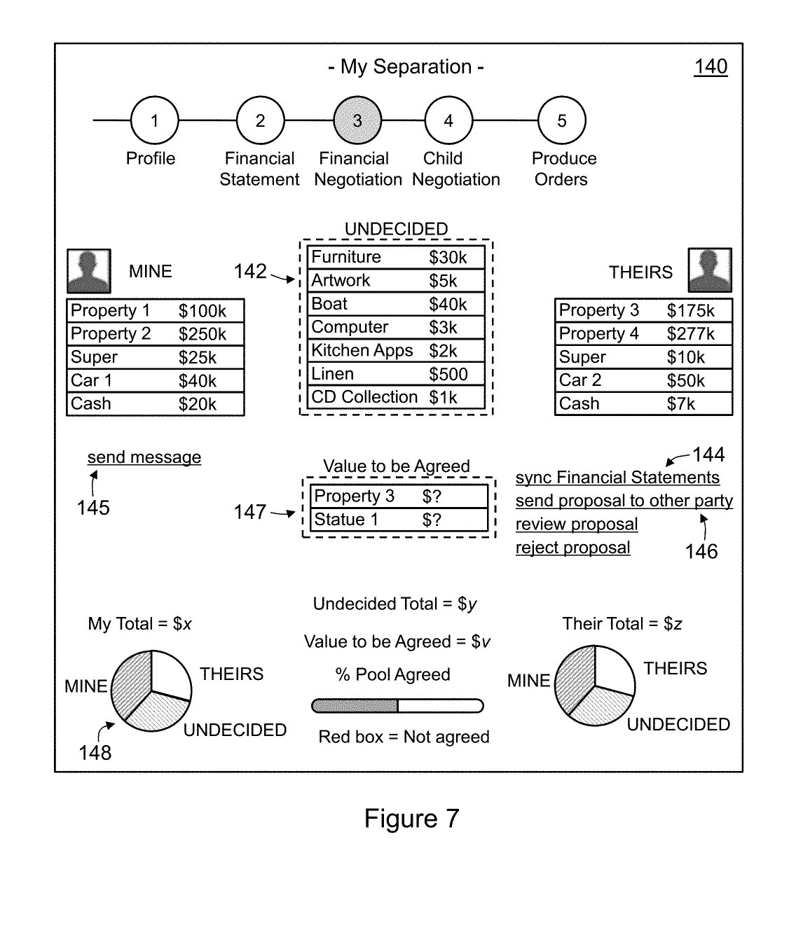

Once the value of a disputed ASSET, LIABILITY or FINANCIAL RESOURCE is agreed, then a reallocation mechanism (not shown) of financial negotiation module 49 moves the ASSET, LIABILITY or FINANCIAL RESOURCE into an UNDECIDED pool; the reallocated ASSET, LIABILITY or FINANCIAL RESOURCE is then displayed accordingly on a financial negotiation page (see FIG. 7). If synced and both individuals agree on the values of all ASSETS, LIABILITIES and FINANCIAL RESOURCES, then there will be no items in dispute (viz. classified as Value To Be Agreed) and the totals of each of the ASSETS, LIABILITIES and FINANCIAL

RESOURCES—as displayed to each Individual on the financial negotiation page—will agree. In the present embodiment, this stage is indicated by displaying a single total for the ASSETS, a single total for LIABILITIES, and a single total for FINANCIAL RESOURCES (rather than separate totals for each individual) on the financial negotiation page.

If synced, and there are ASSETS, LIABILITIES or FINANCIAL RESOURCES with values not agreed, then there will be different totals for Individuals 1 and 2. For each user session, the total ASSETS, LIABILITIES and FINANCIAL RESOURCES will be those stated for that user. Hence, after synchronisation, system 10 displays matching financial statement pages (cf. FIG. 5) and financial negotiation pages (cf. FIG. 7) of each or all Individuals, with any disputed ASSETS, LIABILITIES or FINANCIAL RESOURCES flagged. Once all values are agreed, the users will have sessions with agreeing financial statement pages.

If an ASSET, LIABILITY or FINANCIAL RESOURCE is to be deleted, a confirmation pop-up “Confirm you want to delete Y/N” is displayed.

The table has two columns for the values in the back end system—one denoting Individual 1's valuation, and one denoting Individual 2's valuation. The second column for Individual 2 (the other individual) is populated only once a sync operation is performed.

The “Sync Financial Statements” link or button 122 populates the ASSETS, LIABILITIES and FINANCIAL RESOURCES from the other individual alongside those ASSETS, LIABILITIES and FINANCIAL RESOURCES of Individual 1 in the back-end, and perform an update of the respective Financial Statement pages for each Individual, including for those ASSETS, LIABILITIES and FINANCIAL RESOURCES where the value is not agreed (see the VALUE TO BE AGREED pool on the financial negotiation page, discussed below).

There is a colour legend displayed (i.e. “Red box=Not Agreed” 124, though it should be noted that the exemplary ‘red box’ of this figure is illustrated as dashed box 126).

If sync occurs once “Financial Negotiation” has commenced, any previously agreed ASSETS, LIABILITIES and FINANCIAL RESOURCES whose value has changed are moved by the reallocation mechanism back into the UNDECIDED pool (discussed below).

### Financial Negotiation

FIG. 7 is a schematic view 140 of the page generated by financial negotiation module 49 of application 16. This module allows individuals to negotiate a split of the joint financial portfolio comprising assets, liabilities and financial resources. Financial negotiation module 49 implements a drag and drop paradigm to allocate assets between individuals, to split assets, liabilities and financial resources between individuals, and allows individuals to send proposals between each other.

Financial negotiation module 49 also handles assets, liabilities or financial resources whose values are not yet agreed (e.g. awaiting third-party valuation), and is designed to allow individuals to continue to negotiate the allocation of ASSETS, LIABILITIES and FINANCIAL RESOURCES even if the financial position (valuation) is not finalised.

That is, even though subsequent negotiation steps may require one or more results of the financial negotiation or financial valuation (part of the Financial Statement page), at least some of those steps may proceed even though the valuation of ASSETS, LIABILITIES and FINANCIAL RESOURCES (also financial negotiation but not involving the allocation of ASSETS, LIABILITIES and FINANCIAL RESOURCES to individuals) is incomplete. This prevents complete ‘roadblocks’ arising from lack of agreement on such matters, and so accelerates the process of agreement. As individuals can use this functionality from their laptops or other devices from home, for example, formal mediation facilities and associated costs may be avoided. In this embodiment, this module must be purchased to be used.

When assets/liabilities/resources are split in financial negotiation module 49, the values are transferred directly into the relevant individuals' pools and, if a split asset/liability/resource is deleted, the aggregate asset/liability/resource value appears back in the “to be decided” pool and the split asset/liability/resource items are removed from the individual Participant's pools.

### Business Requirements/Rules

Financial negotiation module 49 supports plural sessions, as there are plural individuals (in this example, two individuals), and stores or flags each ASSET, LIABILITY or FINANCIAL RESOURCE as belonging to one of four pools in part or in total. These pools are termed, in this embodiment, MINE 61a, THEIRS 61b, UNDECIDED 61c (to which all assets, liabilities and resources are typically initially allocated), and VALUE TO BE AGREED 61d. It will be appreciated that, in embodiments in which there are more than two users/individuals, there will be a plurality of THEIRS pools corresponding to the plurality of other users.

Only when all Individuals input their agreement that an ASSET, LIABILITY or FINANCIAL RESOURCE sits with the appropriate individual (as agreed portions if relevant, as there are ASSETS, such as superannuation, that may need to be split so may not be allocated in their entirety) does the reallocation mechanism of financial negotiation module 49 move that item from the UNDECIDED pool 61c to the appropriate pool.

If an ASSET, LIABILITY or FINANCIAL RESOURCE is allocated to different Individuals, it remains in the UNDECIDED pool 61c but is displayed in a red box (e.g. box 142, depicted with dashed lines). If the ASSET, LIABILITY or FINANCIAL RESOURCE has not been allocated to all Individuals (and hence sits as UNDECIDED by one or both Individuals), financial negotiation module 49 retains the ASSET, LIABILITY or FINANCIAL RESOURCE in that pool and does not colour it with a red box.

Financial negotiation module 49 employs a sync mechanism 144 or secure messaging 145. Financial negotiation module 49 provides links 146 for the individuals to send proposals to the other individual/party.

The recipient of a proposal can ACCEPT, REJECT or make a COUNTER-PROPOSAL. The proposal looks like the financial negotiation page 140 and includes the pie chart displaying the share of net assets with the proposed change highlighted.

The four pools can comprise ASSETS, LIABILITIES and FINANCIAL RESOURCES (denoted as positive, negative and positive values respectively). As discussed above, all ASSETS, LIABILITIES and FINANCIAL RESOURCES from the financial statement are typically initially in the UNDECIDED pool 61c (with, optionally, a scroll bar for any or all of the four pools if the associated list of ASSETS, LIABILITIES and FINANCIAL RESOURCES is long, such as being too long to display conveniently).

The user can swipe each ASSET, LIABILITY or FINANCIAL RESOURCE to their pool or another or the other Individual's pool; ASSETS can be moved independently of LIABILITIES and FINANCIAL RESOURCES. The user can swipe an ASSET, LIABILITY or FINANCIAL RESOURCE back from the MINE or THEIRS pool 61a, 61b to another pool (e.g. to the other individual's pool or back to the UNDECIDED pool 61c but not to the VALUE TO BE AGREED pool 61d).

ASSETS, LIABILITIES or FINANCIAL RESOURCES in the VALUE TO BE AGREED pool cannot be moved to any of the other pools; these are highlighted in red (e.g. by red box 147, depicted with dashed lines) on the financial negotiation page 140.

Financial negotiation module 49 displays a pie chart 148 with % labels denoting the relative split between Individuals 1 and 2. Financial negotiation module 49 updates pie chart 148 each time an asset is moved to the MINE or THEIRS pools 61a, 61b, or from either of those pools to the UNDECIDED pool 61c.

Financial negotiation module 49 determines and displays a total dollar value $x, $y, $z, $v for each of the four pools MINE 61a, UNDECIDED 61c, THEIRS 61b and TO BE AGREE 61d respectively. Financial negotiation module 49 updates these totals each time an ASSET, LIABILITY or FINANCIAL RESOURCE is moved to the MINE or THEIRS pools 61a, 61b, or from either of those pools to the UNDECIDED pool 61c.

Financial negotiation module 49 includes a mechanism, activated—for example—via a right click option or with a split button 128, to split a selected or highlighted ASSET (e.g. cash or superannuation), LIABILITY or FINANCIAL RESOURCE into two (or optionally more) items. In response to the activation of this split mechanism, financial negotiation module 49 displays a pop-up that allows a dollar value to be entered by each Individual. The amount must be fully split so there is no leftover amount. Splitting an ASSET, LIABILITY or FINANCIAL RESOURCE prompts financial negotiation module 49 to generate a further item on the financial negotiation page with an incrementing number (e.g. Superannuation Individual 1, when split into two, may become Super1 Individual 1 and Super1 Individual 2) that can be moved mutually independently between the pools.

In the synced case, financial negotiation module 49 displays—in the example of two Individuals—two pie charts and two sets of totals, as described above, the first located under the MINE pool and denoting the percentage and dollar split from Individual 1's perspective, and the second located under the THEIRS pool and denoting the percentage and dollar split from Individual 2's perspective. This is saved in the respective sessions with snapshots written to a central server 76. Once a “sync financial negotiation” has occurred and if less than predefined threshold (e.g. 20%) of the value remains to be agreed, financial negotiation module 49 displays a pop-up message stating “you are both close to finalising and preserving your future wealth by using ‘My Separation’ . . . keep going!”.

### Child Negotiation

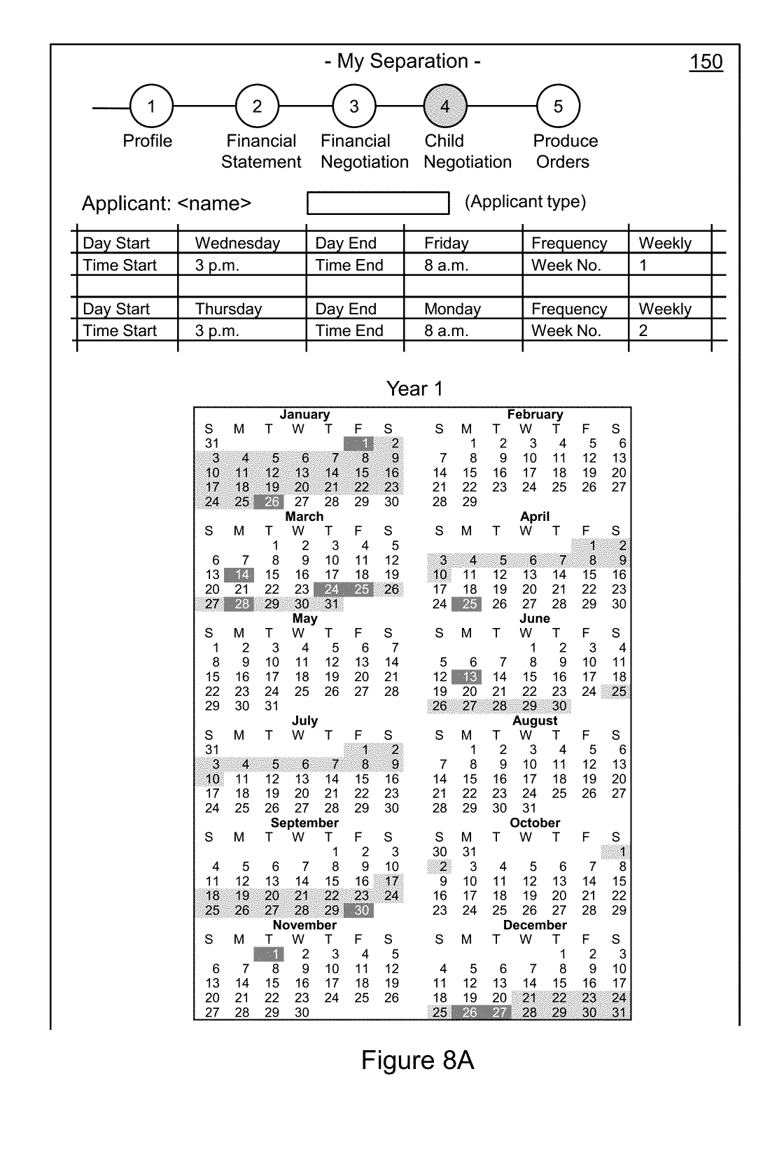

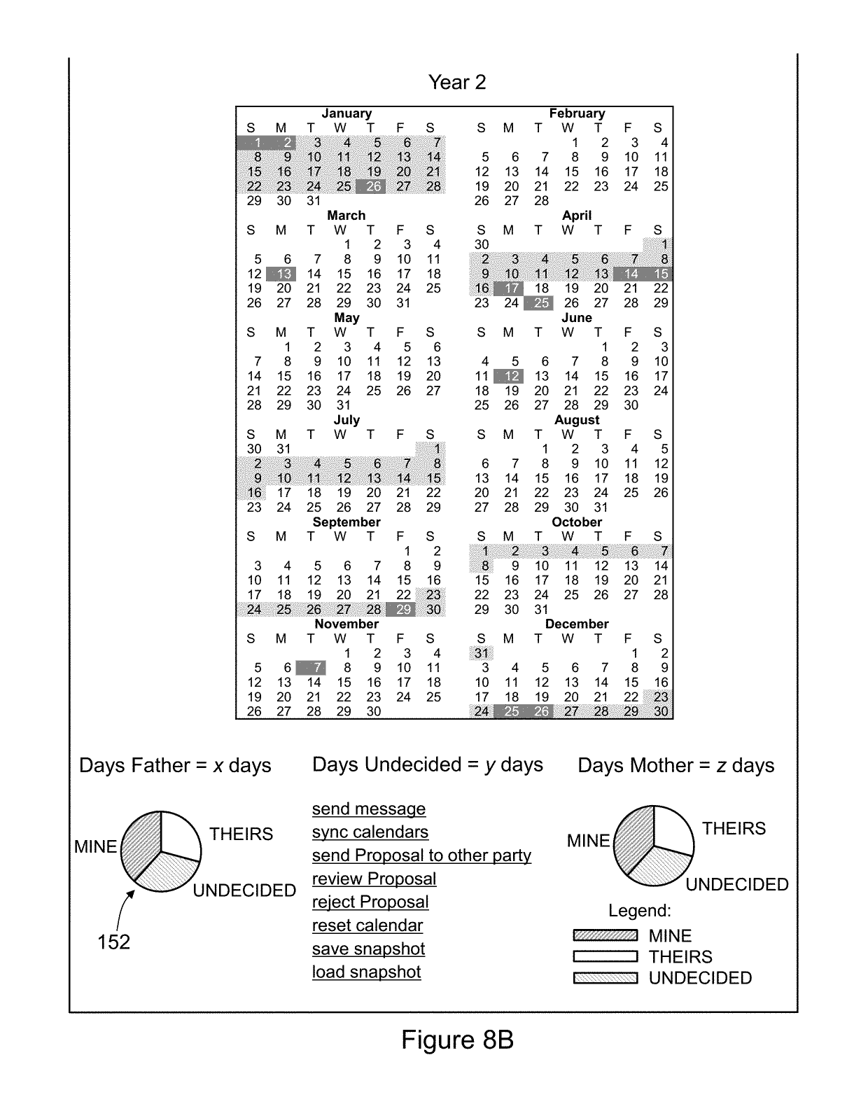

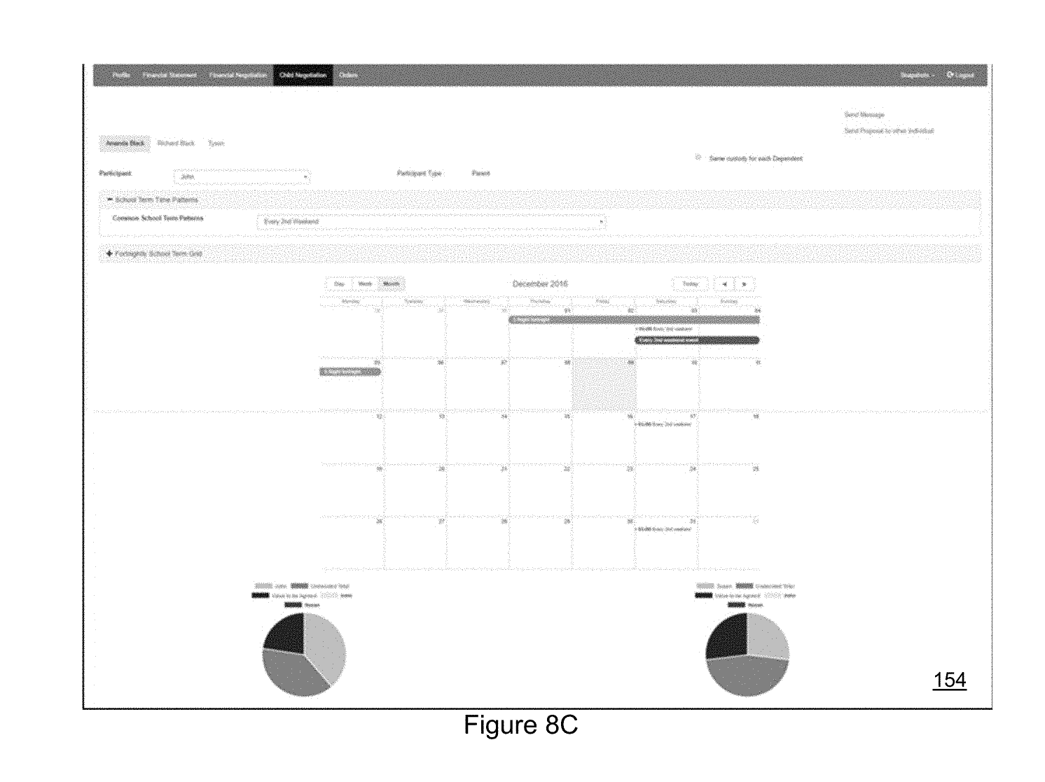

FIGS. 8A and 8B present a schematic view 150 of a page generated by child negotiation module 50 of application 16. Child negotiation module 50 allows the plurality of individuals to negotiate access to or custody of children and/or pets over a rolling window of up to two years. Child negotiation module 50 implements a method of selecting days by toggling each date between the individuals. Individuals can send proposals between themselves. Holding the mouse click and dragging the mouse allows the user to select a range of days. Individuals can again use this functionality from their laptops or other devices from home. In this embodiment, child negotiation module 50 must be purchased to be used.

FIG. 8C is a schematic view 154 of the page generated by the child negotiation module 50 of system 30 according to another embodiment of the present invention.

### Business Requirements/Rules

Child negotiation module 50 displays a grid of check boxes and/or a drop-down menu identifying the most common access sharing structures, including (for example):
50-50 alternating—weekly
50-50 alternating—fortnightly
Wed-Friday for Week 1, Thursday-Monday for Week 2 rolling every 2 weeks
etc.

Selecting one or more of these options prompts child negotiation module 50 to populate the calendar accordingly as a starting point to any further negotiation or refinement (if required).

Child negotiation module 50 also displays—in the alternative embodiment of FIG. 8C—a grid of days (n×7 days) that a user can use to select the nights that they want a given dependent. Selecting boxes in this grid prompts child negotiation module 50 to populate the calendar accordingly as a starting point to any further negotiation or refinement (if required).

Separate children/pets appear as separate tabs in child negotiation module 50, with names pre-populated from profile module 40.

Individuals are flagged as MOTHER, FATHER, which drives the corresponding flagging of Father's Day or Mother's Day in the calendar as a default but can be over-ridden manually (as can all day allocations).

Individual names are pre-populated from the PROFILE page. Individual type is selected with a drop down list (including MOTHER, FATHER, GRANDFATHER, GRANDMOTHER, GUARDIAN MOTHER, and GUARDIAN FATHER). It is possible for both individuals to be MOTHERs or FATHERs.

Child negotiation module 50 displays a calendar, whose default view is monthly and based on Year 1 and Year 2 (as holiday allocations may differ year to year but alternate). i.e. Year 1 Jan, Year 1 Feb . . . Year 2 Dec.

When the check boxes referred to above are checked, child negotiation module 50 highlights the corresponding dates in the calendar, with each individual's time highlighted in different colours for MINE and THEIRS and UNDECIDED. A colour legend (not shown) is displayed (such as MINE=light green, THEIRS=light blue, UNDECIDED=light grey).

Birthdays and Father's Day/Mother's Day should, according to this embodiment, be populated in the Profile page if child negotiation module 50 is to be used. The module displays a message to the user asking him or her to insert his or her respective birthday so that this information can be used by child negotiation module 50, if that module has been purchased and is in use.

If both individuals are MOTHERs or FATHERs, child negotiation module 50 initially allocates Individual 1 the relevant celebration day and Individual 2 the relevant other celebration day; these allocations can be overridden manually by the users—as they can for any of the days in the negotiation period.

The ‘sync calendars’ bring the two proposed calendars together to determine the extent of agreement. The page displays agreed days and days UNDECIDED. This relies on the sync mechanism and otherwise negotiation is done via secure messaging. Otherwise, either Individual can send proposal scenarios where the page can be sent to the other individual for acceptance/rejection/counter-proposal.

By clicking on an individual day on the calendar, the colour (and associated time allocation) MUST cycle through MINE, THEIRS, UNDECIDED. This allows the individual to change the allocation of any day (including overriding previous allocations). It is possible to email a pdf file or the like of the agreed schedule. The print out is in colour and reflects the colours on-screen (viz. FATHER (blue), MOTHER (green), UNDECIDED (grey)).

A user can control application 16 database management system 62 to save a snapshot of the calendar on the website into matter database 60 and to timestamp it appropriately for that individual's records; if this saving is done at least once, the user will be provided with a drop down list of previously-saved snapshots. The user can control application 16 to load a previous snapshot for use by application 16 as the current agreement.

Child negotiation module 50 displays a pie chart 152 with % labels denoting the relative split between Individuals 1 and 2, and updates the pie chart each time a check box is checked or un-checked, or if a day is checked on un-checked on the calendar.

Once a “sync calendars” has occurred and if less than 20% of the days to agree, child negotiation module 50 displays a pop up message stating “you are both close to finalising and saving your hard earned wealth by using ‘My Separation’ . . . keep going!”.

Child negotiation module 50 displays a button (“Transfer Calendar”) to allow the agreed access scheme to be input as calendar invites in a mailer (such as Gmail™ or Microsoft Outlook™). Child negotiation module 50 displays links for the individual to send proposals to the other individual.

The recipient of a proposal can ACCEPT, REJECT or make a COUNTER-PROPOSAL. The proposal looks like the child negotiation page and includes the pie chart displaying the share of time along with the differences highlighted.

In a particular implementation, each page in child negotiation module 50 represents a view for that child/dependent and Participant. When the Participant is changed, the ‘Common School Term Patterns’ and the ‘Fortnightly School Term Grid’ default to the selections for that Participant but the Calendar contains time allocations for all Participants. The ‘Fortnightly School Term Grid’ differentiates time allocations by both colour and allocation description. The same colour is used consistently with other modules e.g. Financial Negotiation assets for a given Participant.

The ‘Fortnightly School Term Grid’ does not permit time allocations for the same day to overlap. Time allocations on the same day MUST be available to one or more Participants, but this is updated manually by the Participant directly into the calendar.

Child negotiation module 50 may be accessed from the top menu only if the participant has purchased access to the module 50 or has an active subscription.

When a participant accesses child negotiation module 50, the application MUST populate the module with the dependents defined in Profile Module 40. System 30 creates one tab for each dependent (child, pet or otherwise) entered in the Profile Module 40. System 30 defaults to the first dependent on the left-most tab. On the top of each tab, there is a check box (default checked) labelled “same custody for each dependent”. Any changes to the custody schedule MUST be copied/replicated to all other dependents only where this checkbox is selected on the tab for that dependent. If a Participant un-checks this check box for a given dependent and later decides to re-check this check box, then any changes to the linked custody arrangements will then start to be reflected on the given Dependent's tab again.

Custody is defined as follows. Each Participant in the Custody Negotiations is allocated by system 30 with exclusive time with the respective dependents subject to there being no overlapping time allocation. The Participant defaults to the user of system 30, but there is a drop-down list to allocate custody time to other Participants to accelerate the negotiation. The Participant and Participant Type is a complete list of participants from Profile Module 40. The Participant Type is not editable and denotes the relationship to the dependent (i.e. Father, Mother, Grandmother, Grandfather, Uncle, Aunt, Friend). There are three ways for a Participant to enter custody details:

Using a drop down menu of common “School Term Time Patterns”;
Using a grid, such as of 2×7 days, to define a repeating cycle for a “Fortnightly School Term Grid”; and
Using the displayed calendar directly.

All of these sections on the page are collapsible, with a +/− symbol to expand or to contract each section one at a time with section one expanded by default if no other section is populated. The drop down menu is not hidden. The label for the drop down is “Common School Term Patterns”.

The label for the grid is “Fortnightly School Term Grid”, while the label for the calendar is “Calendar”. The drop down menu is populated with common patterns, such as 5 nights a fortnight, 2 nights a week, etc. If a Participant chooses an option from the “Common School Term Patterns” drop-down, the system populates the calendar with those common patterns:

| ID | Description |
|---|---|
| Every | 9 am Saturday week 1 to 6 pm Sunday week 1, 9 am |
| weekend | Saturday week 2 to 6 pm Sunday week 2 |
| Every 2nd | 9 am Saturday week 1 to 6 pm Sunday week 1 |
| weekend | |
| 5 night | 3 pm (after school) Thurs week 1 to 8 am (start of school) |
| fortnight | Tues week 2 |
| 4 night | 3 pm (after school) Mon week 1 to 8 am (start of school) |
| fortnight | Tues week 1, 3 pm (after school) Fri week 1 to 8 am (start |
| | of school) Mon week 2 |
| Week on | 3 pm (after school) Mon week 1 to 8 am (start of school) |
| week off | Mon week 2 |
| Everything | The remaining custody time for that dependent |
| else | |

Child negotiation module 50 fills the calendar and always displays it from the point of view of the Participant using the module. Where one Participant selects another Participant for a custody allocation, a complimentary Pattern ID is selected. Similarly, where subsequent Participants directly negotiate custody for dependents, only Patterns IDs not yet selected (and complementary to existing custody allocations) can be available for selection from the “Common School Term Patterns” drop-down. If the Participant uses the drop-down menu, custody type for each day is set to TERM_TIME.

If the Participant uses the 2×7 day grid (2nd section), system 30 allows the Participant to click on any cell. System 30 presents collapsible help text to the Participant to indicate a cell can be clicked on to provide hour by hour composition for that day. If a cell is clicked, system 30 display a pop-up that allows the Participant to choose a Participant from a list of all Participants. If another participant is selected, the grid indicates that one or multiple participants have access to the dependent on that day using coloured blocks (one per Participant) with the Name of the Participant (populated from the Profile page) in each block; this means that, for split days, there may be more than one Participant block in a given box of the fortnightly grid. If additional Participants are selected from the drop down at the top of the page, system 30 automatically creates an additional row for the additional Participant. If there are n Participants, the grid could have n×2 rows because the grid has two rows per Participant. If the 2nd section is used, the 1st section must collapse and no values will be active from the drop down list in the 1st section. System 30 allows Participants to select individual blocks in the grid and delete them. If a Participant chooses to delete a block prior to saving, they can do so but system 30 responds by displaying a confirmation box. Once saved, If a Participant wants to delete a block from the grid, system 30 sends a message to all Participants who have blocks on the grid informing of this deletion.

Each time a cell is tagged against a given Participant, system 30 populates the calendar accordingly, colours the calendar with a colour associated with the given Participant, and updates the pie chart depicting the split of custody. System 30 applies all changes made to the calendar from the 1st and 2nd section two years out from the system date. System 30 displays a roll-forward button once the user navigates past two years from the current system date. System 30 rolls forward the same agreed patterns for a further two years.

If the Participant uses the 2×7 day grid, system 30 sets custody type for each day to TERM_TIME.

So that the Participant can uses the calendar (3rd section) to enter custody details, the calendar can display Day, Week and Month. In either mode, system 30 presents collapsible help text to the Participant to indicate a range of custody time that can be selected for grouping as a custody type e.g. term holidays.

To enter custody details in Day Mode, a Participant clicks on the day (displaying hours as horizontal bands), clicks a start time, and drags the cursor to the end time then unclick to create a block of time. This selects a period of hours in a given day. If the Participant wants to drag to a subsequent day, he or she drags past midnight and system 30 responds by automatically advancing to the next day. The calendar header shows the day in the month change once the user drags the block of time past midnight for the original day in the month.

Once a Participant has selected a period (in Day, Week or Month Mode) from the calendar, system 30 displays a pop—that includes the start date, start time, end date and end time pre-populated for confirmation. System 30 also asks the Participant to tag this custody period against a Participant (drop down list), to select a custody type (TERM_TIME, SCHOOL HOLIDAY, SPECIAL_DAY etc), and WHERE custody type is SPECIAL_DAY the Participant must enter a label (e.g. music lesson, father's day, birthday, Chinese New Year, etc.).

The calendar section displays only one month at a time, but the Participant can scroll to the left or right to view arrangements in adjoining months.

The ‘Common School Term Patterns’ and the ‘Fortnightly School Term Grid’ populate the relevant week or fortnight, etc, for two years from the date of negotiation. Once a pattern is selected from the ‘Common School Term Patterns’, system 30 removes previous patterns while retaining ad-hoc time allocations.

### Produce Orders

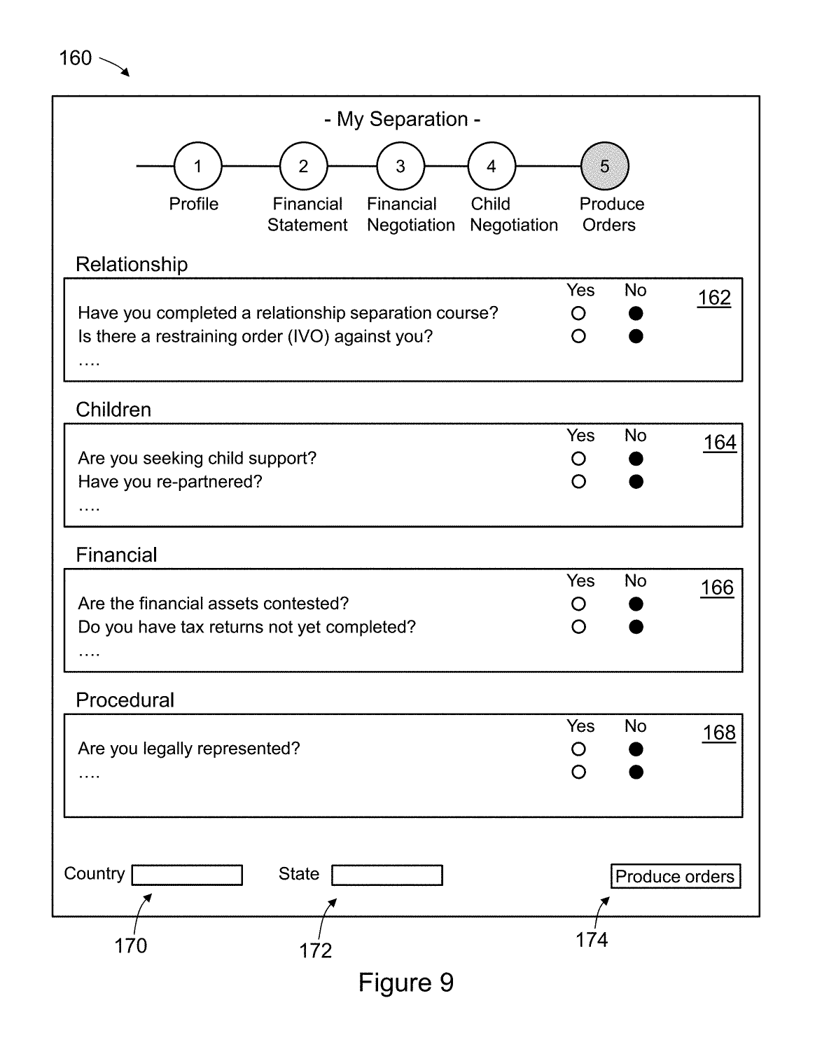

FIG. 9 is a schematic view 160 of the page generated by produce orders manager 45. This module allows individuals to generate draft consent orders for settlement by their solicitor or barrister, and subsequent submission to the Court. Produce orders manager 45 presents a list of supplementary questions that are required to populate the relevant sections of the draft orders, in addition to the outputs of financial negotiation module 49 and/or child negotiation module 50, and information from profile module 40 and financial statement module 47.

Produce orders manager 45 includes (or accesses, such as from order templates and rules database 66) a range of templates to cater for jurisdictional variations, and the supplementary questions will also depend on the relevant jurisdiction. Produce orders manager 45, in this embodiment, must be purchased to be used.

### Business Requirements/Rules

Produce orders manager 45 displays the following questions requiring responses in a table, grouped as follows:

### Relationship 162

Have you completed a relationship separation course?—if N, then ask if we can send info for this via email
Is there a restraining order (e.g. an AVO) against you? If Y, then ask are you permitted to correspond electronically? If N, then no messaging or emails from system 10 will be permitted, only “session sharing” mode

### Children 164

Are you seeking child support? If Y, then complete ‘Form 13’ (to which a link is provided) and enter living costs into the generated form
Have you re-partnered? If Y, then populate column ‘your new partner’ in “Net Assets” and “Negotiate”
Has a family report been prepared? If Y, populate “Children's Days” accordingly. If N, do you want system 10 to recommend a recognised psychologist [i.e. with referrals engine 58]

### Financial 166

Are the financial assets contested? If N, then send finalise option to both parties and prompt the user(s) to request the purchase of produce orders manager 45; ‘Negotiate’ page is greyed out. If Y, that is, financial assets are contested, ask “Do you have independent valuations”? If Y, mark those assets and liabilities as independently valued on the financial statement page 120 with independent valuation checkbox not shown. If N, then ask “Do you want ‘My Separation’ to recommend a recognised valuer?”
Funds contributed to spouse since separation? If Y, then ask “Number of payments (or other contribution)”; Number of payments=‘x’, then Payment 1 &“LABEL” to ‘x’ is listed beneath
Do you have tax returns not yet completed? If Y, how many years are outstanding? Then provide labels for the respective years with an amount for estimate. “Can you arrange an estimate from your accountant on letterhead?”
Do you have a payment plan? If Y, display “Populate your liability and payment amount and frequency on financial statement page 120
Do you have current bank statements for liabilities and certificates for asset ownership and value? (Documents not to be loaded into the site but sent accompanying the orders on the “produce orders” page 160)
Do you have additional third party evidence? Please state the item and nature and indicate on financial statement page 120 that additional documentation to be supplied
Are you receiving government benefits? If Y, cannot have spousal support agreement
Are you seeking spousal maintenance? If Y, then complete ‘Form 13’ (to which a link is provided) and enter living costs into the generated form
If net financial statement is negative, ask “Is net assets position negative?” If Y, ask “Have you considered a bankruptcy claim?”

### Procedural 168

Are you legally represented? Y then provide 8 fields: Solicitor Name, Firm name, Address1, Address2, State, Postcode, phone number, email.

Produce orders manager 45 displays a drop down menu to select in which COUNTRY (at 170) and STATE (at 172) the orders are to be lodged. This selection drives the selection of the relevant templates. Produce orders manager 45 displays a “PRODUCE ORDERS” button 174 that generates a set of orders in pdf and launches Adobe Acrobat or other pdf viewer.

Produce orders manager 45 uses information from profile page 90, the outcomes of the financial and/or child negotiation from financial negotiation module 49 and/or child negotiation module 50, and the answers to the questions described above to produce consent orders using a suitable orders template. The orders templates are stored in order templates and rules database 66. As described above, the orders templates are localised to the relevant country or jurisdiction, and the orders are date and time stamped. Optionally, system 10 may interface with the relevant electronic filing system used by the given jurisdiction (e.g. the Family Court Casetrack system in Australia). The user can generate orders as many times as desired (though only for the named users, to prevent on-selling) once produce orders manager 45 has been purchased.

System 30 may also include a scripting language (referred to as an ‘orders mark-up language’) so that elements of orders may be stored as logical components; these logical components are also stored in order templates and rules database 66 and can be individually updated and selectively combined by system 30 to create orders templates. This allows system 30 to generate an orders template for a particular country or jurisdiction comprising a plurality of these logical components, using a template “agenda”, “TOC” (table of contents) or “instructions” (also stored in order templates and rules database 66) that describe what components constitute a given orders template and in what order. The individual logical components can be static text or contain mappable fields that produce orders manager 45 populates with information from the information submitted in response to prompts presented to users by produce orders manager 45 and/or from other modules, when generating a set of orders. These logical components may contain code loops where instructions to populate content occurs while a given condition is or is not met. (For example, FOR each asset in the financial statement, DO populate the financial orders agreement section). Each logical component and the ultimate orders template is stamped with a country, jurisdiction, start date and end date, so that system 30 can manage orders template versions and individual orders components individually within a given template (while leaving the rest of a particular template unchanged), so that the orders templates need not be updated in their entirely each time one of the logical components is updated. It should be noted that, when creating Orders, system 30 pushes an agreed snapshot of the negotiation (concerning dependent, finances or otherwise) into the Orders to reflect a precise point of agreement between the parties.

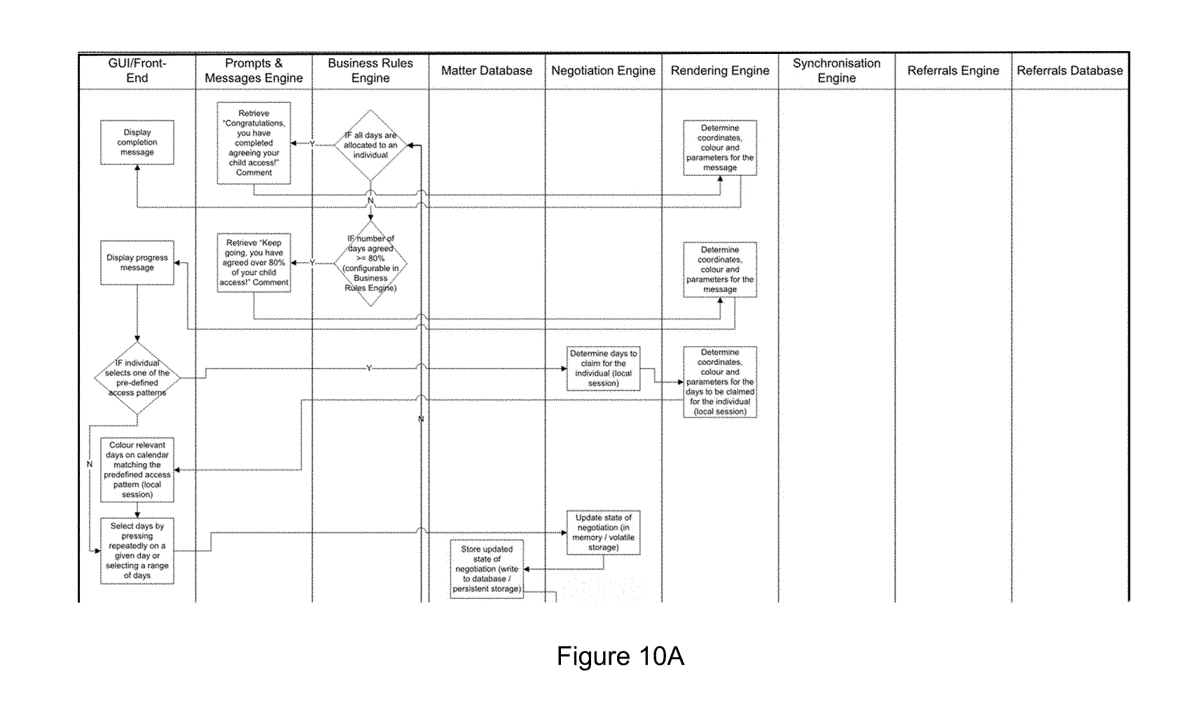

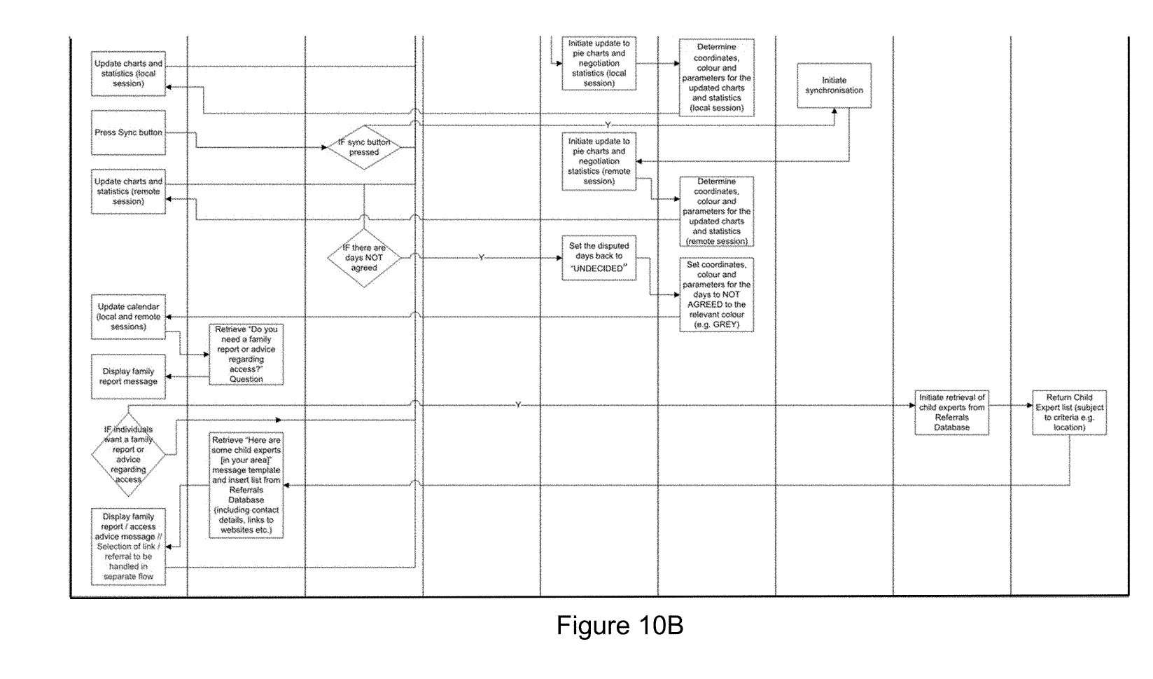

FIGS. 10A and 10B present a flow chart of the process implemented by financial statement module 47 of application 16. This process may also be described by the following pseudo code:

### Financial Statement

// Enter financial information
Box: GUI/Front-end: Enter Asset, Liability or Financial Resource and associated values

### Box: Business Rules Engine: Add Asset, Liability or Financial Resource

### Box: Matter Database: Store Updated Financial Position

Box: GUI/Front-end: Delete Assets, Liabilities or Financial Resources and associated values
Box: Prompts and Messages Engine: Retrieve “Are you sure you want to delete this asset, liability or resource?” message (question)
Box: GUI/Front-end: Display confirmation question
// Handle deletion of items
Diamond: Front-end/GUI: IF confirm intent to delete
YES: Box: Business Rule Engine: Delete asset, liability or resource
   Box: Matter Database: Store updated financial position
   Box: Front-end/GUI: Display completion message
NO: End
   // Update visual representation of financials
   Box: Negotiation Engine: Initiate update to pie charts and financial statistics (local session)
   Box: Rendering Engine: Determine coordinates, colour and parameters for the updated charts and statistics (local session)
   Box: Front-end/GUI: Update charts and statistics (local session)
   // Sync session views between parties
   Box: Front-end/GUI: Press “Sync Financial Statements” button (or link)
   Diamond: Business Rules Engine: IF connected session (to at least one other individual) and the sync button (or link) pressed
NO: [do nothing] // continue with standalone (local) session
YES: Box: Synchronisation Manager: Initiate synchronisation
   Box: Initiate update to pie charts and financial statistics (remote session)
   Box: Rendering Engine: Determine coordinates, colour and parameters for the updated charts and statistics (remote session)
   Box: Front-end/GUI: Update charts and statistics (remote session)
      // Handle values not agreed but allows individuals to keep going and enter/delete/edit ASSETS, LIABILITIES and/or FINANCIAL RESOURCES
      Box: Synchronisation Manager: Initiate synchronisation
      Diamond: Business Rules Engine: IF there are assets, liabilities or resources with values are NOT agreed
NO: Box: Continue // Back to the diamond testing IF the session is connected and the sync button is pressed
YES: Box: Business Rules Engine: identify assets, liabilities or resources with values NOT agreed
   Box: Rendering Engine: Determine coordinates, colour and parameters for the highlight box
   Box: Front-end/GUI: Draw a red line around the disputed asset/liability/resource and display the disputed values (remote and local)
   // Suggest referral
   Box: Prompts and Messages Engine: Retrieve “Do you need an independent valuation?” message
   Box: Front-end/GUI: Display valuation message
   Diamond: Front-end/GUI: IF individuals want a valuer
      NO: Box: Continue // Back to the diamond testing if there are ASSETS/LIABILITIES/RESOURCES with values not agreed
      YES: Box: Referrals Engine: Initiate retrieval of valuers from Referrals Database
         Box: Referrals Database: Return valuer list (subject to one or more criteria e.g. location)
         Box: Prompts and Messages Engine: Retrieve “Here are some valuers [in your area]” message template and insert list from Referrals Database (including contact details, links to websites etc.)
         Box: Front-end/GUI: Display valuer message //Selection of link/referral to be handled in separate flow
         Box: Front-end/GUI: Continue // Back to the diamond testing if there are ASSETS/LIABILITIES/RESOURCES with values not agreed; essentially a DO WHILE loop but cannot draw easily in the flow diagram of FIGS. 10A and 10B so implemented using IF

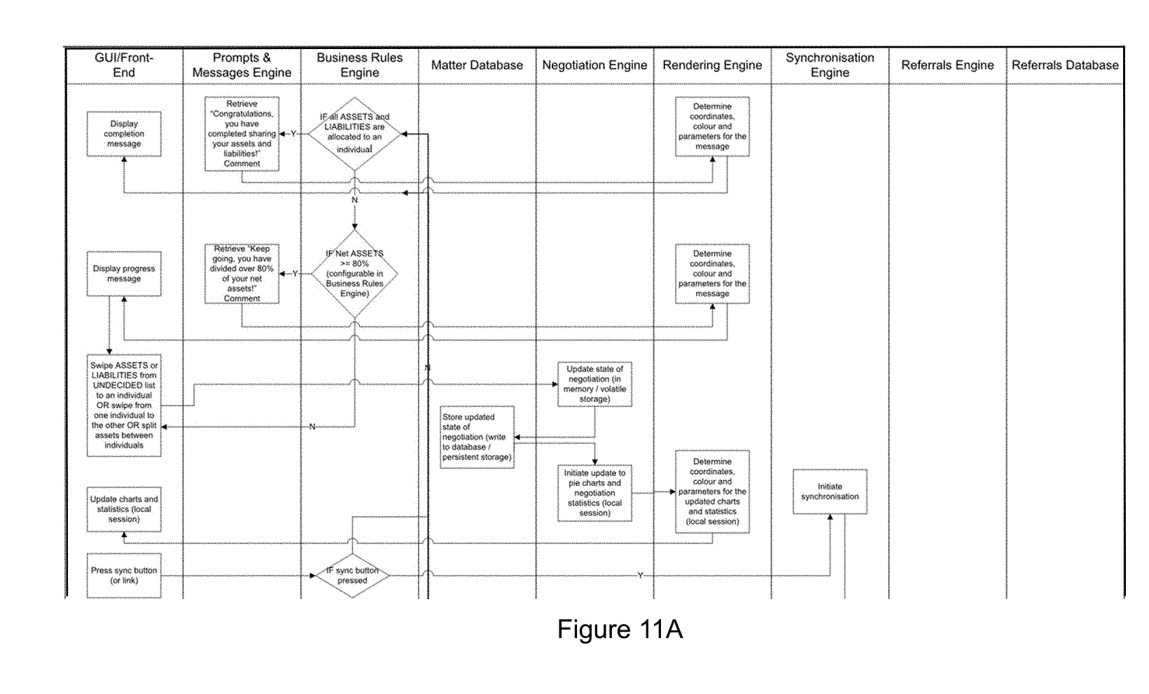

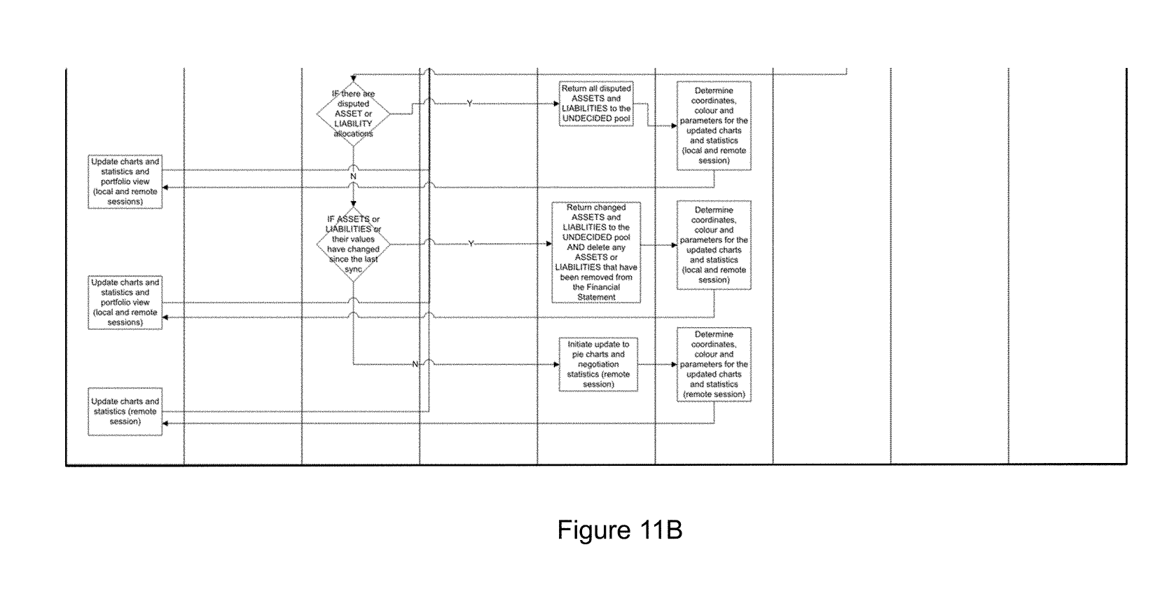

FIGS. 11A and 11B present a flow chart of the process implemented by financial negotiation module 49 of application 16. This process may also be described by the following pseudo code:

### Financial Negotiation Process

// Celebrate success
Diamond: Business Rules Engine: IF all ASSETS, LIABILITIES AND FINANCIAL RESOURCES are allocated to an individual
NO: Continue to next diamond
YES: Box: Messages Engine: Retrieve “Congratulations, you have completed sharing your assets and liabilities!” comment // completion message
   Box: Rendering Engine: Determine coordinates, colour and parameters for the message
   Box: Front-end/GUI: Display completion message
   Box: Front-end/GUI: End
      // Encourage completion
      Diamond: Business Rules Engine: IF Net ASSETS>=80% (configurable in Business Rules Engine)
NO: Continue // move to negotiation (next) sub-flow where individuals allocate ASSETS or LIABILITIES
YES: Box: Messages Engine: Retrieve “Keep going, you have divided over 80% of your net assets!” comment // progress message
   Box: Rendering Engine: Determine coordinates, colour and parameters for the message
   Box: Front-end/GUI: Display progress message
   Box: Front-end/GUI: Continue // move to negotiation (next) sub-flow where individuals allocate ASSETS, LIABILITIES or FINANCIAL RESOURCES
      // Negotiate (manual)
      Box: GUI: Swipe ASSETS, LIABILITIES or FINANCIAL RESOURCES from UNDECIDED list to an individual OR swipe from one individual to the other OR split assets between individuals // IF the allocation of an ASSET, LIABILITY or FINANCIAL RESOURCE is not agreed, the ASSET, LIABILITY or FINANCIAL RESOURCE will stay in the UNDECIDED pool and cannot be moved until both individuals agree—one will swipe the ASSET, LIABILITY or FINANCIAL RESOURCE to their MINE pool and the other individual must swipe the ASSET, LIABILITY or FINANCIAL RESOURCE to their THEIRS pool or vice versa; this allows negotiation to continue even if allocation of one or more ASSETS, LIABILITIES or FINANCIAL RESOURCES is not agreed
      Box: Negotiation Engine: Update state of negotiation (in memory/volatile storage)
      Box: Matter Database: Store updated state of negotiation (write to database/persistent storage)
      Box: Negotiation Engine: Initiate update to pie charts and negotiation statistics (local session)
      Box: Rendering Engine: Determine coordinates, colour and parameters for the updated charts and statistics (local session)
      Box: Front-end/GUI: Update charts and statistics (local session)
      // Sync session views between parties
      Box: Front-end/GUI: Press sync button (or link)
      Diamond: Business Rules Engine: IF sync button pressed
NO: Continue // back to the test IF all ASSETS, LIABILITIES and FINANCIAL RESOURCES are allocated to an individual
YES: Box: Synchronisation Manager: Initiate synchronisation
// Handle disputed ASSET, LIABILITY or FINANCIAL RESOURCE allocations but allows individuals to keep negotiating
Diamond: IF there are disputed ASSET, LIABILITY or FINANCIAL RESOURCE allocations
   YES: Box: Return all disputed ASSETS, LIABILITIES and FINANCIAL RESOURCES to the UNDECIDED pool
      Box: Determine coordinates, colour and parameters for the updated charts and statistics (local and remote sessions)
      Box: Update charts and statistics and portfolio view (local and remote sessions)
      Box: Continue // back to the test IF all ASSETS, LIABILITIES and FINANCIAL RESOURCES are allocated to an individual
   NO: Continue // to next test: IF ASSETS, LIABILITIES or FINANCIAL RESOURCES or their values have changed since the last Sync
// Handle ASSETS, LIABILITIES or FINANCIAL RESOURCES that have changed (added, deleted or changed value)
Diamond: IF ASSETS, LIABILITIES or FINANCIAL RESOURCES or their values have changed since the last Sync
YES: Box: Return changed ASSETS, LIABILITIES and FINANCIAL RESOURCES to the UNDECIDED pool AND delete any ASSETS, LIABILITIES or FINANCIAL RESOURCES which have been removed from the Financial Statement
   Box: Determine coordinates, colour and parameters for the updated charts and statistics AND for the portfolio view (local and remote sessions)
   Box: Update charts and statistics AND portfolio view (local and remote sessions)
   Box: Continue // back to the test IF all ASSETS, LIABILITIES and FINANCIAL RESOURCES are allocated to an individual
NO: Box: Negotiation Engine: Initiate update to pie charts and negotiation statistics (remote session)
   Box: Rendering Engine: Determine coordinates, colour and parameters for the updated charts and statistics (remote session)
   Box: Front-end/GUI: Update charts and statistics (remote session)
   Box: Front-end/GUI: Continue (remote session) // back to the test IF all ASSETS, LIABILITIES or FINANCIAL RESOURCES are allocated to an individual

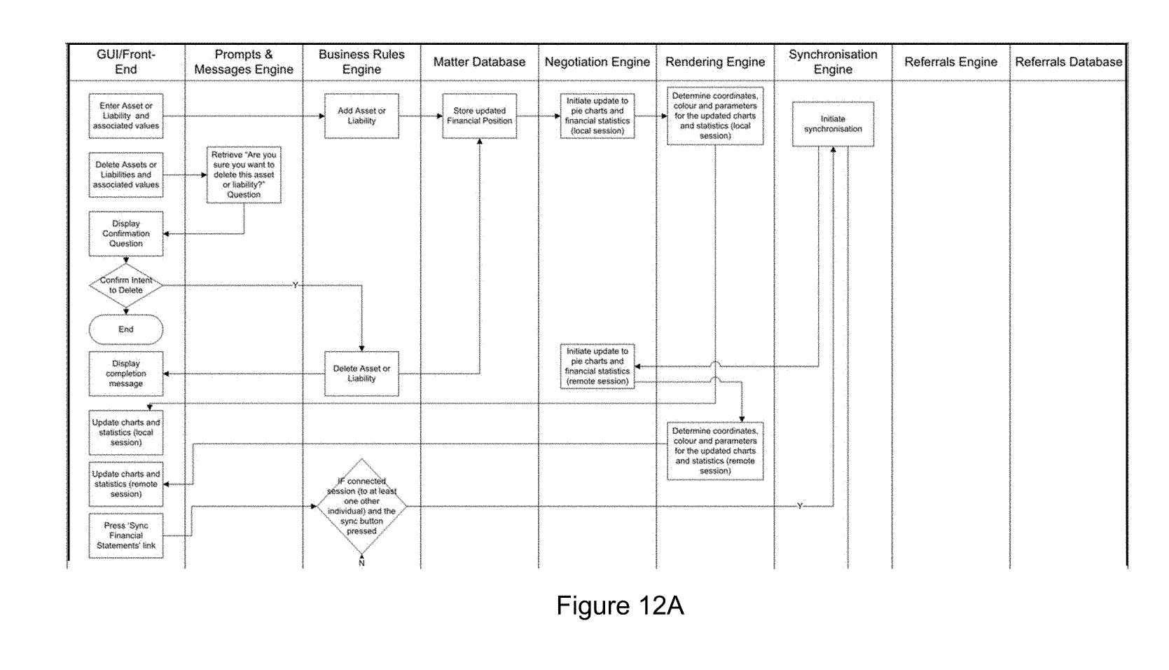

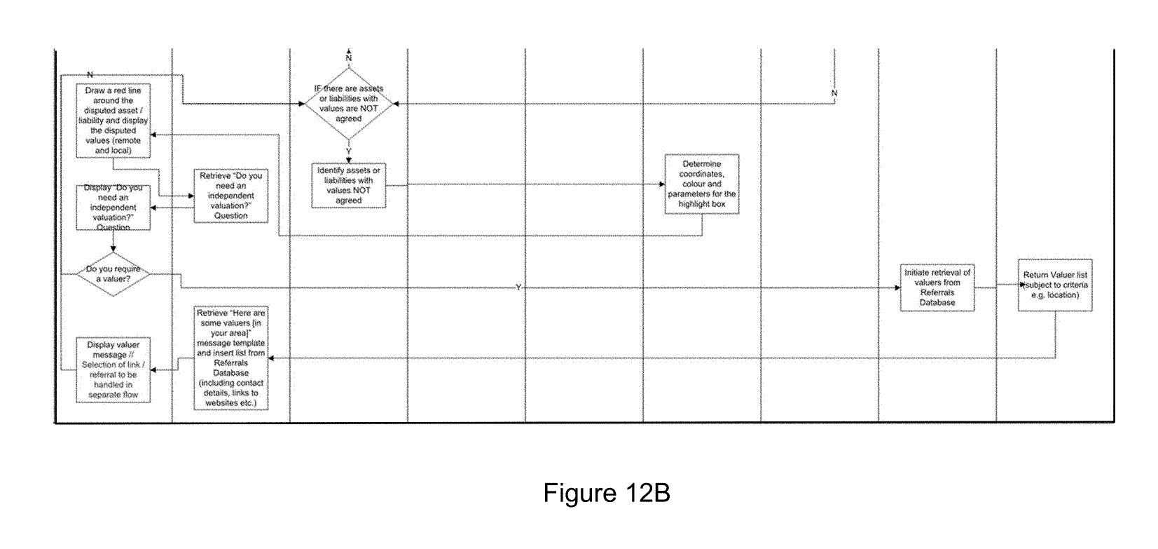

FIGS. 12A and 12B present a flow chart of the process implemented by child negotiation module 50 of application 16. This process may also be described by the following pseudo code:

### Child Negotiation

//Celebrate success
Diamond: Business Rules Engine: IF all days are allocated to an individual
NO: Continue to next diamond
YES: Box: Messages Engine: Retrieve “Congratulations, you have completed agreeing your child access!” comment // success message
   Box: Rendering Engine: Determine coordinates, colour and parameters for the message
   Box: Front-end/GUI: Display completion message
   Box: Front-end/GUI: End
      //Encourage completion
      Diamond: Business Rules Engine: IF number of days agreed>=80% (configurable in Business Rules Engine)
NO: Continue
YES: Box: Messages Engine: Retrieve “Keep going, you have agreed over 80% of your child access!” comment // progress message
   Box: Rendering Engine: Determine coordinates, colour and parameters for the message
   Box: Front-end/GUI: Display message
   Box: Front-end/GUI: Continue // to next sub-flow where individuals can select from pre-defined access patterns if they wish
      // Leverage common access patterns (to accelerate agreement and to minimise the need for repetitive selections)
      Diamond: Front-end/GUI: IF individual selects one of the pre-defined access patterns
NO: Continue // to Negotiate sub-flow
YES: Box: Negotiation Engine: Determine days to claim for the individual (local session)
   Box: Rendering Engine: Determine coordinates, colour and parameters for the days to be claimed for the individual (local session)
   Box: Front-end/GUI: Colour relevant days on calendar matching the predefined access pattern (local session)
   Box: Continue // to Negotiate sub-flow
      // Negotiate (manual)
      Box: Front-end/GUI: Select days by pressing repeatedly on a given day or selecting a range of days
      Box: Negotiation Engine: Update state of negotiation (in memory/volatile storage)
      Box: Matter Database: Store updated state of negotiation (write to database/persistent storage)
      Box: Negotiation Engine: Initiate update to pie charts and negotiation statistics (local session)
      Box: Rendering Engine: Determine coordinates, colour and parameters for the updated charts and statistics (local session)
      Box: Front-end/GUI: Update charts and statistics (local session)
      Box: Front-end/GUI: Continue // Back to the diamond testing IF all days are allocated to an individual
      // Sync session views between parties
      Box: Front-end/GUI: Press sync button
      Diamond: Business Rules Engine: IF sync button pressed
NO: Continue // Back to the diamond testing IF all days are allocated to an individual
YES: Box: Synchronisation Manager: Initiate synchronisation
   Box: Negotiation Engine: Initiate update to pie charts and negotiation statistics (remote session)
   Box: Rendering Engine: Determine coordinates, colour and parameters for the updated charts and statistics (remote session)
   Box: Front-end/GUI: Update charts and statistics (remote session)
   Box: Front-end/GUI: Continue // Back to the diamond testing IF all days are allocated to an individual
   // Handle days not agreed but allows individuals to keep going and selecting days on the calendar
   Diamond: IF there are days NOT agreed
      NO: Return to start // Back to the diamond testing IF all days are allocated to an individual
      YES: Box: Negotiation Engine: Set the disputed days back to “UNDECIDED” //days not agreed remain flagged/coloured as UNDECIDED
         Box: Rendering Engine: Set coordinates, colour and parameters for the days to NOT AGREED to the relevant colour (e.g. GREY)
         Box: Front-end/GUI: Update calendar (local and remote sessions)
         // Suggest Referrals
         Box: Prompts and Messages Engine: Retrieve “Do you need a family report or advice regarding access?”
         Question
         Box: Front-end/GUI: Display family report message
         Diamond: Front-end/GUI: IF individuals want a family report or advice regarding access
         NO: Continue
         YES: Box: Referrals Engine: Initiate retrieval of child experts from Referrals Database
         Box: Referrals Database: Return Child Expert list (subject to one or more criteria e.g. location)
         Box: Prompts and Messages Engine: Retrieve “Here are some child experts [in your area]” message template and insert list from Referrals Database (including contact details, links to websites etc.)
         Box: Front-end/GUI: Display family report/access advice message // Selection of link/referral to be handled in separate flow
         Box: Front-end/GUI: Continue // Back to the diamond testing IF all days are allocated to an individual; essentially a DO WHILE loop but cannot draw easily in the flow diagram of FIGS. 12A and 12B so implemented using IF]

It should also be noted that system 30 may be adapted so that the amount of information need be entered for each module or engine thereof is minimized. Each module or engine presents the minimum number of questions, check boxes etc, required by a user to carry out the function of that module or engine. For example, produce orders manager 45 can access the information submitted by the user(s) in response to prompts presented by profile module 40, financial statement module 47, financial negotiation module 49 and child negotiation module 50, so the user does not—as far as is feasible—have to enter the same information twice. As a result, each module may be regarded as the ‘master module’ for a given piece of information that it receives from the users.

It will be understood to those persons skilled in the art of the invention that many modifications may be made without departing from the scope of the invention.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It will also be understood that the reference to any prior art in this specification is not, and should not be taken as an acknowledgement or any form of suggestion that the prior art forms part of the common general knowledge in any country.

1. A method for processing data sets that disagree, comprising:
a) receiving a plurality of data sets of corresponding elements from a respective plurality of corresponding users required to agree on an outcome, wherein at least some of the elements of the data sets correspond to:
i) financial values;
ii) assets, liabilities or financial resources of the users; and/or
iii) dependent access;
b) comparing elements of corresponding elements of the data sets;
c) identifying one or more corresponding elements of the data sets that are not in agreement across all of the data sets;
d) outputting the corresponding elements of the data sets that are not in agreement across all of the data sets to the users;
e) alerting the users to the one or more elements of the respective data set corresponding to the respective user that are not in agreement across all of the data sets;
f) receiving amendment input from at least one of the users;
g) amending at least one of the data sets according to the amendment input; and
h) checking whether there remain any corresponding elements of the data sets that are not in agreement across all of the data sets.

2. (canceled)

3. The method as claimed in claim 1, including repeating steps c) to h) one or more times, whereby each data set at step q represents a current state of negotiation, until there remain no corresponding elements of the data sets that are not in agreement across all of the data sets.

4. The method as claimed in claim 1, including at least partially further processing the corresponding elements of the data sets that agree across the data sets while continuing to resolve or awaiting resolution of disagreement between the one or more corresponding elements of the data sets that are not in agreement across all of the data sets.

5. The method as claimed in claim 1, including splitting each of one or more corresponding elements of the data sets into a plurality of elements.

6. (canceled)

7. The method as claimed in claim 1, further comprising flagging the corresponding elements of the data sets that are not in agreement across all of the data sets, or storing or flagging the corresponding elements of the data sets that are not in agreement across all of the data sets as undecided.

8. (canceled)

9. (canceled)

10. (canceled)

11. The method as claimed in claim 1, wherein at least some of the elements of the data sets correspond to dependent access comprising presenting to a user a plurality of tools configured to control a child negotiation module that is controllable to negotiate said dependent access.

12. (canceled)

13. The method as claimed in claim 1, further comprising displaying the elements or data indicative of the elements to the users grouped or flagged into a plurality of pools of elements and optionally wherein the pools of elements include at least one pool of corresponding elements of the data sets that are not in agreement across all of the data sets.

14. (canceled)

15. (canceled)

16. (canceled)

17. The method as claimed in claim 1, further comprising preparing statistical information from two or more sets of the plurality of said sets of data, and sending respective messages based at least in part on the statistical information to one or more of the users, and optionally wherein the respective message comprises:
i) at least one recommendation;
ii) at least one recommendation that recommends an expert; or
iii) at least one recommendation that recommends a psychologist or a valuer.

18. (canceled)

19. The method as claimed in claim 1, further comprising generating either automatically or upon user prompting a data snapshot at a point in time comprising selected elements of the data sets and/or of data derived therefrom, and outputting the data snapshot, saving the data snapshot, or sending the data snapshot to one or more of the users, and optionally wherein the data snapshot comprises any one or more of (i) a financial statement, (ii) a financial negotiation outcome, and (iii) a dependent access outcome, and optionally further comprising sending the data snapshot to one or more of the users for agreement.

20. (canceled)

21. (canceled)

22. (canceled)

23. A system for processing data sets that disagree, comprising:
an input for receiving a plurality of data sets of corresponding elements from a respective plurality of corresponding users required to agree on an outcome, and to receive amendment input from at least one of the users, wherein at least some of the elements of the data sets correspond to:
i) financial values;
ii) assets, liabilities or financial resources of the users; and/or
iii) dependent access;
a memory for storing the plurality of data sets;
a negotiation engine for comparing elements of corresponding elements of the data sets and identifying one or more corresponding elements of the data sets that are not in agreement across all of the data sets;
an output for outputting the corresponding elements of the data sets that are not in agreement across all of the data sets to the users; and
a prompts and messages engine configured to alert the users to the one or more elements of the respective data set corresponding to the respective user that are not in agreement across all of the data sets;
wherein the negotiation engine is further configured to respond to receiving amendment input by amending at least one of the data sets according to the amendment input and checking whether there remain any corresponding elements of the data sets that are not in agreement across all of the data sets.

24. The system as claimed in claim 23, comprising a produce orders manager for producing orders indicative of the data sets amended according to the amendment input.

25. (canceled)

26. (canceled)

27. The system as claimed in claim 23, configured to at least partially further process the corresponding elements of the data sets that agree across the data sets before disagreement between the one or more corresponding elements of the data sets is resolved, and preferably i) alert the users to the one or more elements of the respective data set corresponding to the respective user that are not in agreement across all of the data sets, ii) receive amendment input from at least one of the users, iii) amend at least one of the data sets according to the amendment input, iv) check whether there remain any corresponding elements of the data sets that are not in agreement across all of the data sets, and repeat steps i) to iv) one or more times until there remain no corresponding elements of the data sets that are not in agreement across all of the data sets.

28. The system as claimed in claim 23, controllable to split each of one or more corresponding elements of the data sets into a plurality of elements.

29. (canceled)

30. The system as claimed in claim 23, wherein at least some of the elements of the data sets correspond to dependent access and the system includes a child negotiation module controllable to negotiate the dependent access and having a plurality of tools presentable to the user, wherein the tools are configured to control the child negotiation module.

31. (canceled)

32. The system as claimed in claim 23, operable to flag the corresponding elements of the data sets that are not in agreement across all of the data sets, or store or flag the corresponding elements of the data sets that are not in agreement across all of the data sets as undecided.

33. (canceled)

34. The system as claimed in claim 23, configured to display the elements or data indicative of the elements to the users grouped or flagged into a plurality of pools of elements, and optionally the pools of elements include at least one pool of corresponding elements of the data sets that are not in agreement across all of the data sets.

35. (canceled)

36. (canceled)

37. The system as claimed in claim 34, including a reallocation mechanism operable to move at least some of the elements between pools.

38. The system as claimed in claim 23, further comprising a monitoring and reporting engine, wherein the monitoring and reporting engine is configured to prepare statistical information from two or more sets of the plurality of said sets of data, wherein the prompts and messages engine is further configured to send respective messages based at least in part on the statistical information to one or more of the users, and optionally the respective message comprises:
i) at least one recommendation;
ii) at least one recommendation that recommends an expert; or
iii) at least one recommendation that recommends a psychologist or a valuer.

39. (canceled)

40. (canceled)

41. The system as claimed in claim 38, wherein the system or one or more component monitors thereof are configured to generate either automatically or upon user prompting a data snapshot at a point in time comprising selected elements of the data sets and/or of data derived therefrom, and to output the data snapshot, save the data snapshot, or send the data snapshot to one or more of the users.

42. The system as claimed in claim 38, wherein the system or one or more of its component modules may be configured to generate events that in aggregate comprise a matter timeline comprising one or more events in the system.

43. (canceled)

44. (canceled)
